(19) United States
(12) Patent Application Publication
(10) Pub. No.: US 2011/0045357 A1
(43) Pub. Date: Feb. 24, 2011

(54) ELECTROLYTE AND CELL

(75) Inventors: Midori Saito, Miyagi (JP); Takehiko Ishii, Fukushima (JP); Nobuyuki Ohyagi, Fukushima (JP)

Correspondence Address: K&L Gates LLP, P. O. BOX 1135, CHICAGO, IL, 60690, US

(73) Assignee: SONY CORPORATION, Tokyo (JP)

(21) Appl. No.: 12/853,743

(22) Filed: Aug. 10, 2010

(30) Foreign Application Priority Data
Aug. 21, 2009 (JP) 2009-192246

(51) Int. Cl. H01M 6/16; H01M 6/04

(52) U.S. Cl. 429/303; 429/347

(57) ABSTRACT

Disclosed herein is an electrolyte including: a solvent; an electrolyte salt; and an alkanamine derivative represented by the following formula (1):

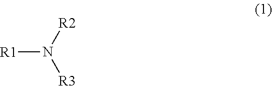

where R1 is an alkyl group of 1 to 3 carbon atoms which may have a substituent group, and R2 and R3 are each independently a sulfonyl group having a substituent group of 1 to 3 carbon atoms or a sulfinyl group having a substituent group of 1 to 3 carbon atoms.

### CROSS REFERENCES TO RELATED APPLICATIONS

The present application claims priority to Japanese Priority Patent Application JP 2009-192246 filed with the Japan Patent Office on Aug. 21, 2009, the entire content of which is hereby incorporated by reference.

### BACKGROUND

The present application relates to an electrolyte and a cell. More particularly, the application relates to a nonaqueous electrolyte including an organic solvent and an electrolyte salt, and to a nonaqueous electrolyte cell in which the nonaqueous electrolyte is used.

In recent years, portable electronic apparatuses such as camcorders, cell phones and notebook type PCs (personal computers) have been widespread, and there has been a keen request for these apparatuses with a reduced size, a reduced weight and a prolonged lifetime. Attendant on this, development of cells or batteries, particularly, secondary cells or batteries capable of showing a high energy density with lightweightness, as power source for the portable electronic apparatuses, has been under way.

Among others, lithium ion secondary cells or batteries in which occlusion and release of lithium are utilized for charge-discharge reactions and lithium metal secondary cells or batteries in which precipitation (deposition) and dissolution of lithium are utilized for charge-discharge reactions have been expected greatly as the above-mentioned power source, because they can show higher energy densities as compared with lead cells or batteries and nickel-cadmium cells or batteries.

With respect to the composition of electrolytes for use in these secondary cells, some technologies aimed at improvements in various performances have already been proposed.

For examples, Japanese Patent Laid-open No. Hei 8-236155 (hereinafter referred to as Patent Document 1) proposes a technology for enhancing charge-discharge cycle characteristics and preservability of lithium ion secondary cells by addition of an amine compound such as triethylamine, diphenylamine, triphenylamine, ethylenediamine, etc. to an electrolyte solution.

Besides, for instance, Japanese Patent Laid-open No. Hei 6-333598 (hereinafter referred to as Patent Document 2) proposes a technology for enhancing charge-discharge cycle characteristics of lithium metal secondary cells by addition of a trialkylamine or triarylamine compound to an electrolyte solution.

Further, for example, Japanese Patent Laid-open No. Hei 10-144347 (hereinafter referred to as Patent Document 3) proposes a technology in which triethanolamine is added to an electrolyte for the purpose of improving discharge characteristics or charge-discharge characteristics.

### SUMMARY

Along with the trend toward electronic apparatuses showing enhanced performance and an increased number of functions, recently, cells and batteries for use in the electronic apparatuses have come to be demanded to exhibit enhanced characteristics. For instance, the just-mentioned trend is accompanied by more frequent repetition of charging and discharging of secondary cells or batteries. Accordingly, the cells or batteries for use in these electronic apparatuses are demanded to be more enhanced in charge-discharge cycle characteristics.

Besides, for instance, there is an inclination toward generation of increased amounts of heat due to such causes as enhancement of performances of electronic parts represented by CPUs (central processing units). As a result, the cells or batteries used in the electronic apparatuses are left in a high-temperature atmosphere. Accordingly, the cells or batteries for use in the electronic apparatuses are demanded to be more enhanced in high-temperature preservability, as well.

However, none of the technologies described in Patent Documents 1 to 3 is successful in sufficiently enhancing both charge-discharge cycle characteristics and high-temperature preservability of cells or batteries.

Thus, there is a need for an electrolyte and a cell with which both enhanced charge-discharge cycle characteristics and enhanced high-temperature preservability can be realized.

According to an embodiment, there is provided an electrolyte including:

a solvent;

an electrolyte salt; and

an alkanamine derivative represented by the following formula (1):

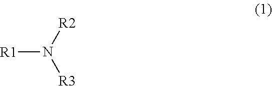

where R1 is an alkyl group of 1 to 3 carbon atoms which may have a substituent group, and R2 and R3 are each independently a sulfonyl group having a substituent group of 1 to 3 carbon atoms or a sulfinyl group having a substituent group of 1 to 3 carbon atoms.

According to another embodiment, there is provided a cell including:

a positive electrode;

a negative electrode; and

an electrolyte including a solvent and an electrolyte salt,

wherein the electrolyte includes an alkanamine derivative represented by the following formula (1):

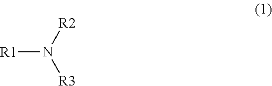

where R1 is an alkyl group of 1 to 3 carbon atoms which may have a substituent group, and R2 and R3 are each independently a sulfonyl group having a substituent group of 1 to 3 carbon atoms or a sulfinyl group having a substituent group of 1 to 3 carbon atoms.

Thus, the electrolyte according to the embodiment includes the alkanamine derivative represented by the above formula (1), whereby a decomposition reaction in the case of using the electrolyte in an electrochemical device such as a cell can be suppressed, as compared with electrolytes which do not include the alkanamine derivative represented by the formula (1).

In the cell according to the embodiment of the application, the presence of the alkanamine derivative of the formula (1) in the electrolyte enhances electrochemical stability of the electrolyte, whereby charge-discharge cycle characteristics and high-temperature preservability of the cell can be enhanced.

According to the present application, consequently, enhanced charge-discharge cycle characteristics and enhanced high-temperature preservability of a cell can be realized.

Additional features and advantages are described herein, and will be apparent from the following Detailed Description and the figures.

### BRIEF DESCRIPTION OF THE FIGURES

FIG. 1 is a sectional view showing an exemplary configuration of a cell according to a second embodiment;

FIG. 2 is a sectional view showing, in an enlarged form, a part of a wound electrode body shown in FIG. 1;

FIG. 3 is an exploded perspective view showing an exemplary configuration of a cell according to a fifth embodiment of the application; and

FIG. 4 is a sectional view of the wound electrode body, taken along line I-I of FIG. 3.

### DETAILED DESCRIPTION

The present application is described below in detail with reference to the drawings according to an embodiment. The detailed description is provided as follows:

1. First embodiment (Electrolyte)

2. Second embodiment (First example of cell)

3. Third embodiment (Second example of cell)

4. Fourth embodiment (Third example of cell)

5. Fifth embodiment (Fourth example of cell)

6. Sixth embodiment (Fifth example of cell)

7. Other embodiments (Modifications)

### 1. First Embodiment

Electrolyte Solution

An electrolyte solution according to a first embodiment will be described. The electrolyte solution according to the first embodiment of the application is for use in electrochemical devices such as cells. The electrolyte solution contains a solvent, an electrolyte salt, and an alkanamine derivative represented by the following formula (1):

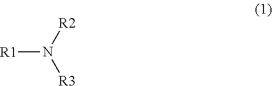

where R1 is an alkyl group of 1 to 3 carbon atoms which may have a substituent group, and R2 and R3 are each independently a sulfonyl group having a substituent group of 1 to 3 carbon atoms or a sulfinyl group having a substituent group of 1 to 3 carbon atoms.

Solvent

The solvent includes, for example, a nonaqueous solvent such as organic solvents. Examples of the nonaqueous solvent include cyclic carbonic acid esters such as ethylene carbonate, propylene carbonate, butylenes carbonate, etc., chain carbonic acid esters such as dimethyl carbonate, diethyl carbonate, ethyl methyl carbonate, methyl propyl carbonate, etc., γ-butyrolactone, γ-valerolactone, 1,2-dimethoxyethane, tetrahydrofuran, 2-methyltetrahydrofuran, tetrahydropyran, 1,3-dioxolan, 4-methyl-1,3-dioxolan, 1,3-dioxane, 1,4-dioxane, methyl acetate, ethyl acetate, methyl propionate, ethyl propionate, methyl butyrate, methyl isobutyrate, methyl trimethylacetate, ethyl trim ethyl acetate, acetonitrile, glutaronitrile, adiponitrile, methoxyacetonitrile, 3-methoxypropionitrile, N,N-dimethylforamide, N-methylpyrrolidinone, N-methyloxazolidinone, N,N-dimethylimidazolidinone, nitromethane, nitroethane, succinonitrile, sulfolane, dimethyl sulfoxide-phosphoric acid, etc. These nonaqueous solvents ensure that excellent capacity characteristic, cycle characteristic and preservability can be obtained in electrochemical devices having the electrolyte solution. These nonaqueous solvents may be used either singly or in mixture of two or more of them.

Especially, the solvent preferably contains, in mixture, a solvent having a high viscosity (high dielectric constant) (e.g., a relative dielectric constant ε≧30) such as ethylene carbonate, propylene carbonate, etc. and a solvent having a low viscosity (e.g., a viscosity ≦1 mPa·s) such as dimethyl carbonate, ethyl methyl carbonate, diethyl carbonate, etc. Such a mixed solvent enhances dissociability of the electrolyte salt and mobility of ions, making it possible to obtain a higher effect.

Besides, examples of other applicable solvents than the above-mentioned include ethylene fluorocarbonates such as 4-fluoro-1,3-dioxolan-2-one (FEC), 4,5-difluoro-1,3-dioxolan-2-one (DFEC), etc., which further enhance the chemical stability of the electrolyte solution.

Examples of still other applicable solvents than the above-mentioned include cyclic carbonic acid esters having an unsaturated bond, such as vinylene carbonate (VC), vinylethylene carbonate (VEC), etc., which further enhance the chemical stability of the electrolyte solution.

Electrolyte Salt

The electrolyte salt includes a light metal salt such as lithium salt, for example. Examples of the lithium salt include lithium hexafluorophosphate (LiPF₆), lithium tetrafluoroborate (LiBF₄), lithium perchlorate (LiClO₄), lithium hexafluoroarsenate (LiAsF₆), lithium tetraphenylborate (LiB(C₆H₅)₄), lithium methanesulfonate (LiCH₃SO₃), lithium trifluoromethanesulfonate (LiCF₃SO₃), lithium bis(trifluoromethanesulfonyl)imide (LiTFSI; LiN(CF₃SO₂)₂), lithium bis(pentafluoroethanesulfonyl)imide (LiN(C₂F₅SO₂)₂), lithium tetrachloroaluminate (LiAlCl₄), lithium hexafluorosilicate (Li₂SiF₆), lithium chloride (LiCl), lithium bromide (LiBr), etc., which may be used either singly or in mixture of two or more of them.

Especially, the electrolyte salt preferably contains lithium hexafluorophosphate, which leads to a lowered internal resistance, thereby making it possible to obtain excellent capacity characteristic, cycle characteristic and preservability in an electrochemical device having the electrolyte solution.

The content of the electrolyte salt is preferably in the range of 0.3 to 3.0 mol/kg, based on the solvent. If the content of the electrolyte salt is outside this range, ionic conductivity would be lowered extremely, so that it might be impossible to obtain sufficient capacity characteristic or the like in an electrochemical device having the electrolyte solution.

Alkanamine Derivative

The electrolyte solution contains an alkanamine derivative represented by the above formula (1), as an additive. The presence of the alkanamine derivative of the formula (1) in the electrolyte solution restrains a decomposition reaction of the electrolyte solution. As a result, in an electrochemical device including an electrolyte solution containing the alkanamine derivative represented by the formula (1), excellent cycle characteristics and high-temperature preservability can be obtained.

The content of the alkanamine derivative represented by the formula (1) is preferably in the range of 0.001 to 5 mass % (hereinafter referred to as wt. %), based on the whole amount of the electrolyte solution, since it ensures that a higher effect can be obtained.

In the electrolyte solution, the alkanamine derivative represented by the formula (1) may be contained either singly or in mixture of two or more of them.

Examples of the alkyl group of 1 to 3 carbon atoms which may have a substituent group, in the formula (1), include methyl, ethyl, propyl, methoxyl, ethoxyl, propoxyl, perfluoromethyl, perfluoroethyl and perfluoropropyl groups. Examples of the sulfonyl group having a substituent group of 1 to 3 carbon atoms, in the formula (1), include perfluoromethylsulfonyl, perfluoroethylsulfonyl and perfluoropropylsulfonyl groups. Examples of the sulfinyl group having a substituent group of 1 to 3 carbon atoms, in the formula (1), include perfluoromethoxysulfinyl, perfluoroethoxysulfinyl and perfluoropropoxysulfinyl groups.

Examples of the alkanamine derivative represented by the above formula (1) include alkanamine derivatives represented by the formula (2) and alkanamine derivatives represented by the formula (3):

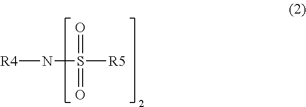

where R4 is an alkyl group of 1 to 3 carbon atoms, an alkoxyl group of 1 to 3 carbon atoms, or a perfluoroalkyl group of 1 to 3 carbon atoms, and R5 is a perfluoroalkyl group of 1 to 3 carbon atoms;

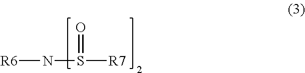

where R6 is an alkyl group of 1 to 3 carbon atoms, an alkoxyl group of 1 to 3 carbon atoms, or a perfluoroalkyl group of 1 to 3 carbon atoms, and R7 is a perfluoroalkyl group of 1 to 3 carbon atoms.

Specific examples of the alkanamine derivatives represented by the above formula (2) include N-methylbis((trifluoromethyl)sulfonyl)imide represented by the following formula (4), N-ethylbis((trifluoromethyl)sulfonyl)imide represented by the following formula (5), N-propylbis((trifluoromethyl)sulfonyl)imide represented by the following formula (6), N-methylbis((pentafluoroethyl)sulfonyl)imide represented by the following formula (7), N-ethylbis((pentafluoroethyl)sulfonyl)imide represented by the following formula (8), N-trifluoromethylbis((trifluoromethyl)sulfonyl)imide represented by the following formula (9), N-methoxybis((trifluoromethyl)sulfonyl)imide represented by the following formula (10), and N-ethoxybis((trifluoromethyl)sulfonyl)imide represented by the following formula (11).

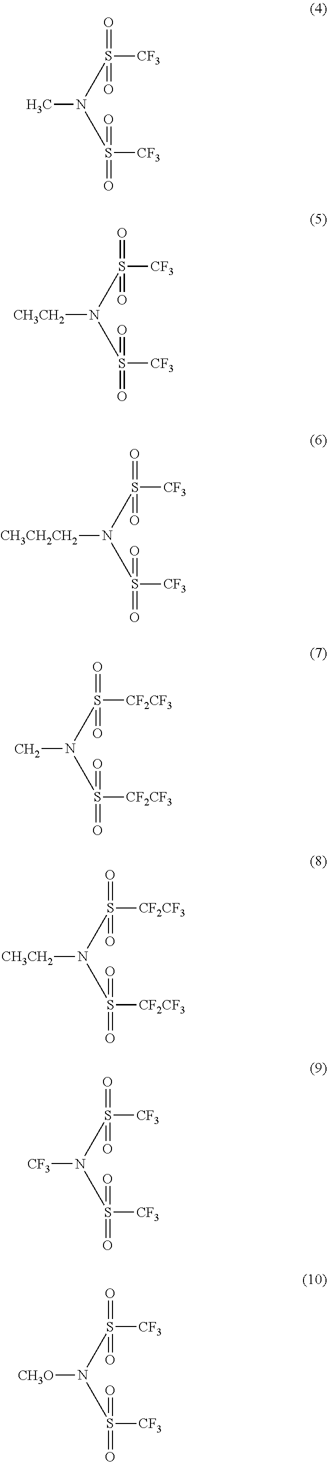

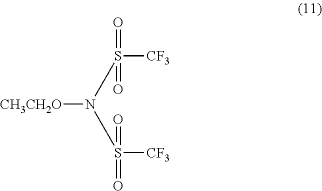

Specific examples of the alkanamine derivatives represented by the above formula (3) include N-methylbis(trifluoromethoxysulfinyl)imide represented by the following formula (12), N-ethylbis(trifluoromethoxysulfinyl)imide represented by the following formula (13), N-propylbis(trifluoromethoxysulfinyl)imide represented by the following formula (14), N-methylbis(pentafluoroethoxysulfinyl)imide represented by the following formula (15), N-ethylbis(pentafluoroethoxysulfinyl)imide represented by the following formula (16), N-trifluoromethylbis(trifluromethoxysulfinyl)imide represented by the following formula (17), N-methoxybis(trifluoromethoxysulfinyl)imide represented by the following formula (18), and N-ethoxybis(trifluoromethoxysulfinyl)imide represented by the following formula (19).

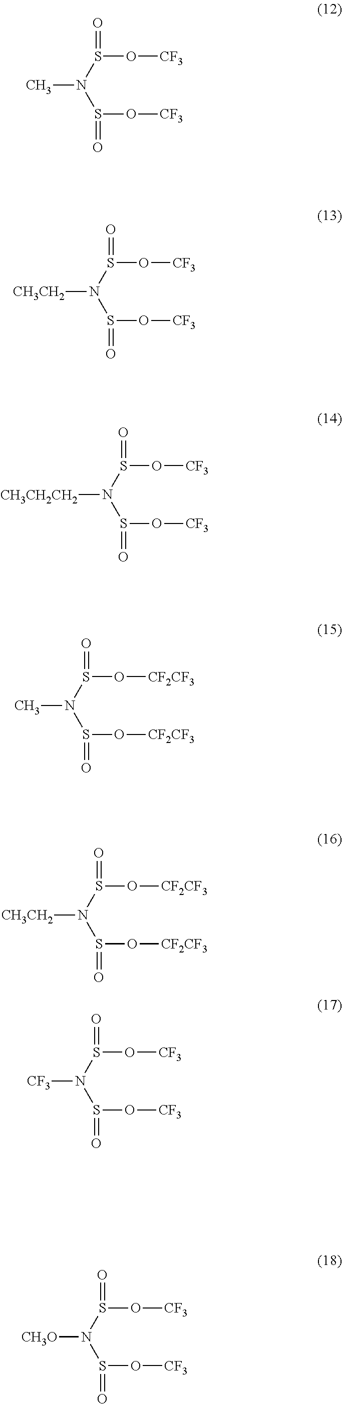

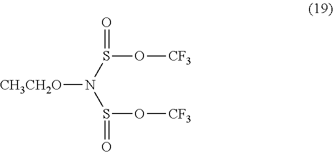

Incidentally, these alkanamine derivatives can be obtained by known synthesizing methods. For instance, these alkanamine derivatives can be obtained by referring to the synthesizing methods described in Chem. Commun., 2003, pp. 2334 to 2335.

Effect

The electrolyte solution according to the first embodiment contains the alkanamine derivative represented by the above formula (1) together with the solvent and the electrolyte salt, whereby a decomposition reaction of the electrolyte solution when the electrolyte solution is used for an electrochemical device such as a cell is suppressed, as compared with the case where an electrolyte solution does not contain the alkanamine derivative represented by the formula (1). Since electrochemical stability of the electrolyte solution, electrochemical device using the electrolyte solution can contribute to favorable cycle characteristics and preservability.

### 2. Second Embodiment

A cell according to a second embodiment will be described. The cell according to the second embodiment of the application is an example of an electrochemical device in which the above-described electrolyte solution is used. Now, the cell according to the second embodiment of the application will be described below, referring to the drawings.

Configuration of Cell

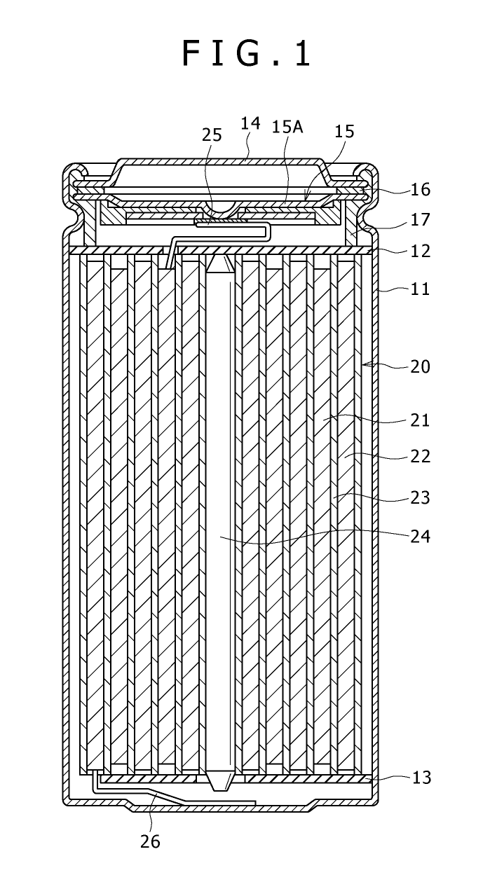

FIG. 1 shows a sectional configuration of a cell according to a second embodiment. This cell is a nonaqueous electrolyte cell in which an electrolyte solution containing an organic solvent is used. Besides, this cell is a lithium ion secondary cell in which the capacity of a negative electrode is represented by a capacity component based on the occlusion and release of lithium serving as an electrode reaction substance. The cell has a cell structure called “cylindrical type.”

The cell has a configuration in which a wound electrode body 20 having a positive electrode 21 and a negative electrode 22 wound with a separator 23 sandwiched therebetween and a pair of insulating plates 12 and 13 are accommodated in the inside of a substantially hollow cylindrical cell can 11. The cell can 11 is formed, for example, from nickel (Ni)-plated iron (Fe), and its one end portion and its other end portion are closed and opened, respectively. The pair of insulating plates 12 and 13 are so disposed as to clamp the wound electrode body 20 therebetween and to extend perpendicularly to the circumferential surface of the wound body.

At the open end portion of the cell can 11, a cell cap 14 as well as a safety valve mechanism 15 and a positive temperature coefficient (PTC) thermistor 16 which are provided inside the cell can 14 is attached by caulking the end portion, with a gasket 17 therebetween, whereby the inside of the cell can 11 is hermetically sealed. The cell cap 14 is formed, for example, from a material identical or similar to the material of the cell can 11. The safety valve mechanism 15 is electrically connected to the cell cap 14 through the thermistor 16.

The safety valve mechanism 15 is so configured that when the internal pressure reaches or exceeds a predetermined pressure due to internal short-circuiting or external heating, a disk plate 15A is reversed, to cut off the electrical connection between the cell cap 14 and the wound electrode body 20. The thermistor 16 limits a current by an increase in its resistance according to a rise in temperature, thereby preventing abnormal heat generation from arising from a large current. The gasket 17 is formed, for example, from an insulating material, with its surface coated with asphalt.

A center pin 24, for example, is inserted in the center of the wound electrode body 20. In the wound electrode body 20, a positive electrode lead 25 formed of aluminum (Al) or the like is connected to the positive electrode 21, and a negative electrode lead 26 formed of nickel or the like is connected to the negative electrode 22. The positive electrode lead 25 is welded to the safety valve mechanism 15, whereby it is electrically connected to the cell cap 14, whereas the negative electrode lead 26 is welded to the cell can 11, whereby it is electrically connected to the cell can 11.

Positive Electrode

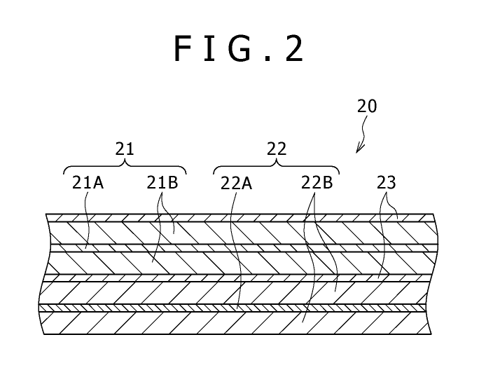

FIG. 2 shows, in an enlarged form, a part of the wound electrode body 20 shown in FIG. 1. The positive electrode 21 has a structure in which, for example, positive electrode active material layers 21B are provided on both sides of a positive electrode current collector 21A which has a pair of opposite sides (surfaces). The positive electrode current collector 21A is formed, for example, from a metallic material such as aluminum (Al), nickel (Ni) and stainless steel (SUS). The positive electrode active material layers 21B contain, as a positive electrode active material, for example, one or more positive electrode materials which can occlude and release lithium serving as an electrode reaction substance. The positive electrode active material layers 21B may contain a conductive agent, a binder or the like, if necessary.

The positive electrode material which can occlude and release lithium is preferably a lithium-containing compound which contains lithium and a transition metal, because the compound promises a high energy density. Examples of the lithium-containing compound include lithium compound oxide such as lithium cobaltate, lithium nickelate (which have a laminar rock salt structure) or a solid solution (e.g., a solid solution represented by Chemical a) containing them.

LiNiₓCo_{y}Mn_{z}O₂ Chemical a

where the values of x, y and z are such that 0 x 1, 0 y 1, 0 Z 1, and x+y+z=1.

Besides, other examples of the lithium-containing compound include lithium compound oxides such as lithium manganate (LiMn₂O₄) having a spinel structure or its solid solution (Li(Mn₂₋ᵥNiᵥ)O₄; the value of v is in the range v 2). Further examples of the lithium-containing compound include phosphoric acid compounds having an olivine structure, such as lithium iron phosphate (LiFePO₄).

Specific examples of the lithium-containing compound include lithium compound oxides having an average composition represented by Chemical I, more specifically, Chemical II, and lithium compound oxides having an average composition represented by Chemical III.

LipNi(1-q-r)MnqM1rO(2-y)X_{z} Chemical I

where M1 is at least one selected from among the elements of Groups 2 to 15 exclusive of nickel (Ni) and manganese (Mn), X is at least one selected from among the elements of Groups 16 and 17 exclusive of oxygen (O), and the values of p, q, r, y, and z are such that 0≦p≦1.5, 0≦q≦1.0, 0≦r≦1.0, −0.10≦y≦0.20, 0≦z≦0.2. Incidentally, the compositional ratio of lithium varies depending on the charged/discharged state of the cell, and the value of p is the value in a fully discharged state.

LiₐCo_{(1-b)}M2_{b}O_{(2-c)} Chemical II

where M2 is at least one selected from the group consisting of vanadium (V), copper (Cu), zirconium (Zr), zinc (Zn), magnesium (Mg), aluminum (Al), gallium (Ga), yttrium (Y) and iron (Fe), the values of a, b and c are in the ranges 0.9≦a≦1.1, 0≦b≦0.3, −0.1≦c≦0.1. Incidentally, the compositional ratio of lithium varies depending on the charged/discharged state of the cell, and the value of a is the value in a fully discharged state.

LiwNixCoyMnzM3(1-x-y-z)O₍₂₋ᵥ₎ Chemical III

where M3 is at least one selected from the group consisting of vanadium (V), copper (Cu), zirconium (Zr), zinc (Zn), magnesium (Mg), aluminum (Al), gallium (Ga), yttrium (Y) and iron (Fe), and the values of v, w, x, y and z are such that −0.1≦v≦0.1, 0.9≦w≦1.1, 0 x 1, 0 y 1, 0 z 0.5, 0≦1-x-y-z. Incidentally, the compositional ratio of lithium varies depending on the charged/discharged state of the cell, and the value of w is the value in a fully discharged state.

Yet other examples of the lithium-containing compound include, for example, lithium compound oxides having a spinel structure represented by Chemical IV:

LiₚMn_{(2-q)}M4_{q}OᵣFₛ Chemical IV

where M4 is at least one selected from the group consisting of cobalt (Co), nickel (Ni), magnesium (Mg), aluminum (Al), boron (B), titanium (Ti), vanadium (V), chromium (Cr), iron (Fe), copper (Cu), zinc (Zn), molybdenum (Mo), tin (Sn), calcium (Ca), strontium (Sr) and tungsten (W), and the values of p, q, r and s are in the ranges 0.9≦p≦1.1, 0≦q≦0.6, 3.7≦r≦4.1, and 0≦s≦0.1. Incidentally, the compositional ratio of lithium varies depending on the charged/discharged state of the cell, and the value of p is the value in a fully discharged state.

Yet further examples of the lithium-containing compound include lithium compound phosphates having an olivine structure represented by Chemical V, specifically Chemical VI:

LiₐM5_{b}PO₄ Chemical V

where M5 is at least one selected from among the elements of Groups 2 to 15, and the values of a and b are in the ranges 0≦a≦2.0 and 0.5≦b≦2.0. Incidentally, the compositional ratio of lithium varies depending on the charged/discharged state of the cell, and the value of a is the value in a fully discharged state.

LitM6PO4 Chemical VI

where M6 is at least one selected from the group consisting of cobalt (Co), manganese (Mn), iron (Fe), nickel (Ni), magnesium (Mg), aluminum (Al), boron (B), titanium (Ti), vanadium (V), niobium (Nb), copper (Cu), zinc (Zn), molybdenum (Mo), calcium (Ca), strontium (Sr), tungsten (W) and zirconium (Zr), and the value oft is in the range 0.9≦t≦1.1. Incidentally, the compositional ratio of lithium varies depending on the charged/discharged state of the cell, and the value oft is the value in a fully discharged state.

Other examples of the positive electrode material than the above-mentioned include oxides such as titanium oxide, vanadium oxide, manganese oxide, etc., disulfides such as iron disulfide, titanium disulfide, molybdenum disulfide, etc., conductive polymers such as polyaniline, polythiophene, etc., and sulfur.

Negative Electrode

The negative electrode 22 has a structure in which, for example, negative electrode active material layers 22B are provided on both sides of a negative electrode current collector 22A which has a pair of opposite sides (surfaces). The negative electrode current collector 22A is formed, for example, from a metallic material such as copper (Cu), nickel (Ni) and stainless steel (SUS). The negative electrode active material layers 22B contain, as a negative electrode active material, for example, at least one negative electrode material which can occlude and release lithium. The negative electrode active material layers 22B may contain a conductive agent, a binder or the like, if necessary.

Examples of the negative electrode material which can occlude and release lithium include metallic and semimetallic elements which can occlude and release lithium as well as materials having at least one of these metallic and semimetallic elements as a constituent element. Such negative electrode materials are preferable, since they promise a high energy density. The negative electrode materials may each be an elementary substance, alloy or compound of a metallic or semimetallic element, or a material which has one or more phases of the elementary substance, alloy or compound of a metallic or semimetallic element at least at a part thereof. Incidentally, the alloys herein include not only those which are composed of two or more metallic elements but also those which contain at least one metallic element and at least one semimetallic element. Besides, the alloys herein may contain a nonmetallic element. Examples of the structure of the alloys include a solid solution, a eutectic (eutectic mixture), an intermetallic compound, and a structure of coexistence of two or more of them.

Examples of the metallic or semimetallic elements constituting the negative electrode material include metallic or semimetallic elements which can form an alloy with lithium. Specific examples of the metallic or semimetallic elements include magnesium (Mg), boron (B), aluminum (Al), gallium (Ga), indium (In), silicon (Si), germanium (Ge), tin (Sn), lead (Pb), bismuth (Bi), cadmium (Cd), silver (Ag), zinc (Zn), hafnium (Hf), zirconium (Zr), yttrium (Y), palladium (Pd) and platinum (Pt). Among these, particularly preferred is at least one of silicon (Si) and tin (Sn), because its high ability to occlude and release lithium and a high energy density are promised.

Examples of the negative electrode material containing at least one of silicon (Si) and tin (Sn) include an elementary substance, alloys and compounds of silicon, an elementary substance, alloys and compounds of tin, and materials which have one or more phases of these at a part thereof. These may be used either singly or in mixture of two or more of them.

Examples of silicon alloys include those alloys which contain, as a second constituent element other than silicon (Si), at least one selected from the group consisting of tin (Sn), nickel (Ni), copper (Cu), iron (Fe), cobalt (Co), manganese (Mn), zinc (Zn), indium (In), silver (Ag), titanium (Ti), germanium (Ge), bismuth (Bi), antimony (Sb) and chromium (Cr). Examples of tin alloys include those alloys which contain, as a second constituent element other than tin (Sn), at least one selected from the group consisting of silicon (Si), nickel (Ni), copper (Cu), iron (Fe), cobalt (Co), manganese (Mn), zinc (Zn), indium (In), silver (Ag), titanium (Ti), germanium (Ge), bismuth (Bi), antimony (Sb) and chromium (Cr).

Examples of tin compounds or silicon compounds include those which contain oxygen (O) or carbon (C). These compounds may each contain the above-mentioned second constituent element(s) in addition to tin (Sn) or silicon (Si).

Particularly preferred examples of the negative electrode material containing at least one of silicon (Si) and tin (Sn) are those which contain tin (Sn) as a first constituent element and which contain a second constituent element and a third constituent element in addition to tin (Sn). Naturally, such a negative electrode material may be used together with the above-mentioned negative electrode material. Here, the second constituent element is at least one selected from the group consisting of cobalt (Co), iron (Fe), magnesium (Mg), titanium (Ti), vanadium (V), chromium (Cr), manganese (Mn), nickel (Ni), copper (Cu), zinc (Zn), gallium (Ga), zirconium (Zr), niobium (Nb), molybdenum (Mo), silver (Ag), indium (In), cerium (Ce), hafnium (Hf), tantalum (Ta), tungsten (W), bismuth (Bi) and silicon (Si). The third constituent element is at least one selected from the group consisting of boron (B), carbon (C), aluminum (Al) and phosphorus (P). Where the second element and the third element are contained in the negative electrode material, cycle characteristic of the cell is enhanced.

Among others, CoSnC-containing materials are preferred which contain tin (Sn), cobalt (Co) and carbon (C) as constituent elements, in which the content of carbon (C) is in the range of 9.9 to 29.7 wt. %, and in which the ratio (Co/(Sn+Co)) of the content of cobalt (Co) to the total content of tin (Sn) and cobalt (Co) is in the range of 30 to 70 wt. %. When the CoSnC-containing material as the negative electrode material is in such a compositional range, a high energy density and excellent cycle characteristics can be obtained.

Each of the CoSnC-containing materials may further contain other constituent elements, as required. Preferable examples of the other constituent elements include silicon (Si), iron (Fe), nickel (Ni), chromium (Cr), indium (In), niobium (Nb), germanium (Ge), titanium (Ti), molybdenum (Mo), aluminum (Al), phosphorus (P), gallium (Ga) and bismuth (Bi), which may be contained either singly or in combination of two or more of them, whereby capacity characteristic or cycle characteristics are further enhanced.

Preferably, the CoSnC-containing material has a phase which contains tin (Sn), cobalt (Co) and carbon (C), and this phase has a lowly crystalline structure or an amorphous structure. Besides, in the CoSnC-containing material, at least part of carbon present as a constituent element is preferably bonded to a metallic or semimetallic element present as another constituent element. A lowering in cycle characteristics is considered to be due to aggregation or crystallization of tin (Sn) or the like, and such aggregation or crystallization is restrained by bonding of carbon to another element.

Examples of the method for examining the bonding state of elements include the X-ray photoelectron spectroscopy (XPS). In the XPS, using an apparatus having undergone an energy calibration such that the peak (Au4f) of the 4f orbital of gold atom is obtained at 84.0 eV, the peak (C1s) of the 1s orbital of carbon appears at 284.5 eV when the material under examination is graphite. When the material under examination is surface-contaminated carbon, the peak appears at 284.8 eV. On the other hand, in the case where the charge density of the carbon element is enhanced, for example, where carbon is bonded to a metallic or semimetallic element, the C1s peak appears in a range below 284.5 eV. In other words, where the peak of a C1s hybrid wave obtained for a CoSnC-containing material appears in a range below 284.5 eV, at least part of carbon (C) contained in the CoSnC-containing material is in the state of being bonded to a metallic or semimetallic element present as another constituent element.

Incidentally, in XPS, for example, the C1s peak is used for calibration of an energy axis of spectrum. Normally, surface-contaminated carbon is present at the surface of the CoSnC-containing material; therefore, the C1s peak of the surface-contaminated carbon is taken as 284.8 eV, and this is used as an energy reference. In XPS, the C1s peak waveform is obtained as a waveform which contains both the peak of the surface-contaminated carbon and the peak of the carbon in the CoSnC-containing material. Therefore, the peak of the surface-contaminated carbon and the peak of the carbon in the CoSnC-containing material are separated from each other, for example, by an analysis conducted using a commercially available software. In the waveform analysis, the position of a main peak present on the minimum binding energy side is used as an energy reference (284.8 eV).

Examples of the negative electrode material which can occlude and release lithium further include carbon materials, metallic oxides and polymers. Naturally, these negative electrode materials may be used together with the above-mentioned negative electrode materials. Examples of the carbon materials include easily graphitizable carbon, difficultly graphitizable carbon having a spacing of (002) lattice planes of not less than 0.37 nm, and graphite having a spacing of (002) planes of not more than 0.34 nm. More specifically, examples of the carbon materials include pyrolytic carbons, cokes, graphites, vitreous carbons, fired products of organic polymers, carbon fiber, and activated carbon. The cokes include pitch coke, needle coke and petroleum coke. The fired products of organic polymers are carbonized products obtained by firing (burning) of polymers such as phenolic resin, furan resin, etc. at an appropriate temperature. The carbon materials show little changes in crystal structure attendant on occlusion and release of lithium. Therefore, use of the carbon material, for example together with the above-mentioned negative electrode material, is preferable because both a high energy density and excellent cycle characteristics can thereby be obtained and the carbon material functions also as a conductive agent. Examples of the metallic oxides include iron oxide, ruthenium oxide and molybdenum oxide. Examples of the polymers include polyacetylene and polypyrrole.

Conductive Agent

Examples of the conductive agent include carbon materials such as graphite, carbon black and Ketchen black, which may be used either singly or in mixture of two or more of them. Incidentally, the conductive agent may be a metallic material, a conductive polymer or the like insofar as it is an electrically conductive material.

Binder

Examples of the binder include synthetic rubbers such as styrene-butadiene rubber, fluororubber, ethylene-propylene-diene rubber, etc. and such polymeric materials as polyvinylidene fluoride, etc., which may be used either singly or in mixture of two or more of them. It is to be noted here that where the positive electrode 21 and the negative electrode 22 are wound as shown in FIG. 1, it is preferable to use a styrene-butadiene rubber, a fluororubber or the like which is rich in flexibility.

Separator

The separator 23 is a component for isolating the positive electrode 21 and the negative electrode 22 from each other, so as to prevent short-circuit due to mutual contact of the electrodes, and, simultaneously, permitting lithium ions to pass therethrough. The separator 23 is composed, for example, of a porous membrane of a synthetic resin such as polytetrafluoroethylene, polypropylene, polyethylene, etc. or a porous membrane of a ceramic, and may have a laminate structure of these two kinds of porous membranes. Among others, polyolefin-made porous membranes are preferable, since they are excellent in short-circuit preventive effect and they promise enhanced cell safety based on a shut-down effect. Particularly, polyethylene is preferable because a shut-down effect can be thereby obtained in a temperature range of 100 to 160° C. and it is excellent in electrochemical stability. Polypropylene is also preferable. Further, other resins obtained by copolymerization or blending with polyethylene or polypropylene may also be used insofar as they are chemically stable.

The separator 23 is impregnated with the electrolyte solution according to the first embodiment described above, as a liquid electrolyte, whereby excellent cycle characteristics and preservability of a cell can be obtained.

When this cell is charged, for example, lithium ions are released from the positive electrode 21, and are occluded into the negative electrode 22 by way of the electrolyte solution. Upon discharging of the cell, on the other hand, for example, lithium ions are released from the negative electrode 22, and are occluded into the positive electrode 21 by way of the electrolyte solution.

In this cell, quantity control is conducted between the positive electrode active material and the negative electrode material which can occlude and release lithium so that the charging capacity based on the negative electrode material capable of occlusion and release of lithium is greater than the charging capacity based on the positive electrode active material. This ensures that precipitation (deposition) of lithium metal at the negative electrode 22 would not occur even when the cell is fully charged.

The cell may be so set that the open-circuit voltage (namely, cell voltage) in a fully charged state is in the range of, for example, 4.30 to 5.00 V, or, for example, 4.30 to 4.40 V. Where the open-circuit voltage in the fully charged state is not less than 4.30 V, the quantity of lithium released per unit mass of the positive electrode active material is greater and, accordingly, the quantities of the positive electrode active material and the negative electrode active material are controlled and a higher energy density can be obtained, as compared with a cell which uses the same positive electrode active material but in which the open-circuit voltage in the fully charged state is 4.20 V.

Method of Fabricating Cell

The cell as above-described is fabricated, for example, in the following manner.

First, for example, positive electrode active material layers 21B are formed on both sides of a positive electrode current collector 21A, to produce a positive electrode 21. In forming the positive electrode active material layers 21B, a positive electrode composition prepared by mixing a powder of a positive electrode active material with a conductive agent and a binder is dispersed in a solvent such as N-methyl-2-pyrrolidine, to thereby form a pasty positive electrode composition slurry. Then, the positive electrode composition slurry is applied to the positive electrode current collector 21A, and is dried, followed by compression molding.

In addition, for example, following the same procedure as production of the positive electrode 21, negative electrode active material layers 22B are formed on both sides of a negative electrode current collector 22A, to thereby produce a negative electrode 22.

Next, a positive electrode lead 25 is attached to the positive electrode current collector 21A by welding, and a negative electrode lead 26 is attached to the negative electrode current collector 22A by welding.

Subsequently, a positive electrode 21 and a negative electrode 22 are wound, with a separator 23 sandwiched therebetween, to form a wound electrode body 20. Then, a tip portion of the positive electrode lead 25 is welded to a safety valve mechanism 15, a tip portion of the negative electrode lead 26 is welded to a cell can 11, and the wound electrode body 20 is accommodated into the inside of the cell can 11 while clamping the wound electrode body 20 between a pair of insulating plates 12 and 13.

Next, the above-described electrolyte solution is introduced into the inside of the cell can 11, to impregnate the separator 23 with the electrolyte solution. Finally, a cell cap 14, the safety valve mechanism 15 and a thermistor 16 are fixed to an open end portion of the cell can 11 by caulking, with a gasket 17 therebetween. By the above steps, a cell as shown in FIGS. 1 and 2 can be obtained.

Effect

In the cell according to this second embodiment, the electrolyte solution contains an alkanamine derivative represented by the above formula (1). Consequently, in a cell in which the capacity of the negative electrode 22 is represented by a capacity component based on the occlusion and release of lithium, cycle characteristics and preservability can be enhanced.

### 3. Third Embodiment

A cell according to a third embodiment will be described. The cell according to the third embodiment of the application is configured in the same manner as the cell according to the second embodiment of the application, except for the configuration of the negative electrode 22. Therefore, in the following, the configuration of the negative electrode 22 will be described in detail, and detailed descriptions of other configurations will be omitted, since the other configurations are the same as in the cell according to the second embodiment.

Configuration of Negative Electrode

Like in the cell according to the second embodiment, the negative electrode 22 has a structure in which negative electrode active material layers 22B are provided on both sides of the negative electrode current collector 22A. The negative electrode active material layers 22B contains, for example, a negative electrode active material which contains silicon (Si) or tin (Sn) as a constituent element. Silicon (Si) and tin (Sn) are high in ability to occlude and release lithium, and thereby promise a high energy density. Particularly, silicon (Si) is preferred because it is higher in theoretical capacity. Specifically, for example, the negative electrode active material contains an elementary substance, alloy or compound of silicon or an elementary substance, alloy or compound of tin, and may contain two or more of these components.

The negative electrode active material layers 22B are formed, for example, by a vapor phase method, a liquid phase method, a flame spraying method, a firing method, or at least two of these methods. Preferably, the negative electrode active material layer 22B and the negative electrode current collector 22A are alloyed with each other at least at part of the interface therebetween. Specifically, it is preferable that a constituent element of the negative electrode current collector 22A is diffused into the negative electrode active material layer 22B at the interface, or a constituent element of the negative electrode active material layer 22B is diffused into the negative electrode current collector 22A, or the constituent elements are mutually diffused. This ensures that breakage due to expansion and contraction of the negative electrode active material layers 22B attendant on charging and discharging can be restrained, and that electronic conductivity between the negative electrode active material layer 22B and the negative electrode current collector 22A can be enhanced.

Incidentally, examples of the vapor phase method include physical deposition methods and chemical deposition methods, specifically, vacuum evaporation, sputtering, ion plating, laser ablation, thermal CVD (thermal chemical vapor deposition), plasma enhanced CVD, and so on. Examples of the liquid phase method which can be used include known techniques such as electroplating, electroless plating, etc. The firing method is, for example, a method in which a negative electrode active material in the form of particles is mixed with a binder and the like, the mixture is dispersed in a solvent, and the dispersion is applied, followed by a heat treatment at a temperature above the melting point(s) of the binder and the like. As the firing method, also, known techniques can be utilized. Examples of the firing method which can be used include an atmosphere firing method, a reactive firing method, and a hot-press firing method.

Effect

The cell according to the third embodiment has an effect identical or similar to the effect of the cell according to the first embodiment of the application.

### 4. Fourth Embodiment

A cell according to a fourth embodiment will be described. The cell according to the fourth embodiment of the application is a so-called lithium metal secondary cell in which the capacity of a negative electrode 22 is represented by a capacity component based on precipitation (deposition) and dissolution of lithium.

This cell has the same configuration, and is fabricated by the same procedure, as the cell according to the second embodiment above, except that its negative electrode active material layers 22B are composed of lithium metal. Therefore, in the following, the configuration of a negative electrode 22 will be described in detail, and descriptions of other configurations will be omitted.

Configuration of Negative Electrode

This cell uses lithium metal as a negative electrode active material, whereby a higher energy density can be obtained. Negative electrode active material layers 22B may be already provided from the time of assembly, or may be absent at the time of assembly and be composed of lithium metal precipitated (deposited) upon charging. In addition, the negative electrode active material layer 22B may be utilized as a current collector, whereby the negative electrode current collector 22A is omitted.

Upon charging of this cell, for example, lithium ions are released from the positive electrode 21, to be precipitated (deposited) as lithium metal on the surface of the negative electrode current collector 22A by way of the electrolyte solution. On the other hand, upon discharging of the cell, lithium metal is eluted as lithium ions from the negative electrode active material layers 22B, to be occluded into the positive electrode 21 by way of the electrolyte solution.

Effect

In the cell according to the fourth embodiment, the electrolyte solution contains an alkanamine derivative represented by the above formula (1). Consequently, in a cell in which the capacity of the negative electrode 22 is represented by a capacity component based on the precipitation (deposition) and dissolution of lithium, cycle characteristics and preservability can be enhanced.

### 5. Fifth Embodiment

A cell according to a fifth embodiment will be described. The cell according to the fifth embodiment of the application is a cell in which a gelled electrolyte having an electrolyte solution held by a polymer is used.

Configuration of Cell

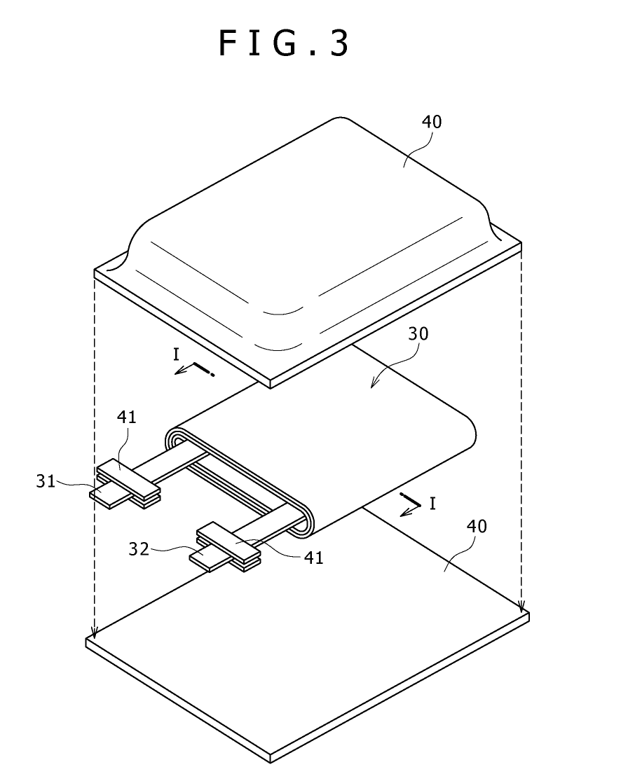

FIG. 3 is an exploded perspective view showing the configuration of the cell according to the fifth embodiment of the application. The cell has a structure in which a wound electrode body 30 with a positive electrode lead 31 and a negative electrode lead 32 attached thereto is accommodated in the inside of film-formed armor members 40. The cell has a cell structure called “laminate film type.”

The positive electrode lead 31 and the negative electrode lead 32 are led out, for example, in the same direction, from the inside to the outside of the armor members 40. Each of these electrode leads is formed, for example, from a metallic material such as aluminum (Al), copper (Cu), nickel (Ni), stainless steel (SUS), etc., and is sheet-like or mesh-like in shape.

The armor member 40 is composed, for example, of a rectangular aluminum laminate film in which a nylon film, an aluminum foil and a polyethylene film are laminated in this order. The armor members 40 each have, for example, the polyethylene film thereof facing the wound electrode body 30, and have their outer edge portions adhered to each other by fusing or by use of an adhesive. Close-contact films 41 for preventing penetration of the outside air are inserted between the armor members 40 and the positive electrode lead 31 and the negative electrode lead 32. The close-contact films 41 are formed from a material which has a property for secure contact with the positive electrode lead 31 and the negative electrode lead 32, for example, a polyolefin resin such as polyethylene, polypropylene, modified polyethylene, modified polypropylene, etc.

Incidentally, the armor members 40 may be formed not from the aluminum laminate film of the three-layer structure described above but from a laminate film of other structure, or from a film of a polymer such as polypropylene, or from a metallic film.

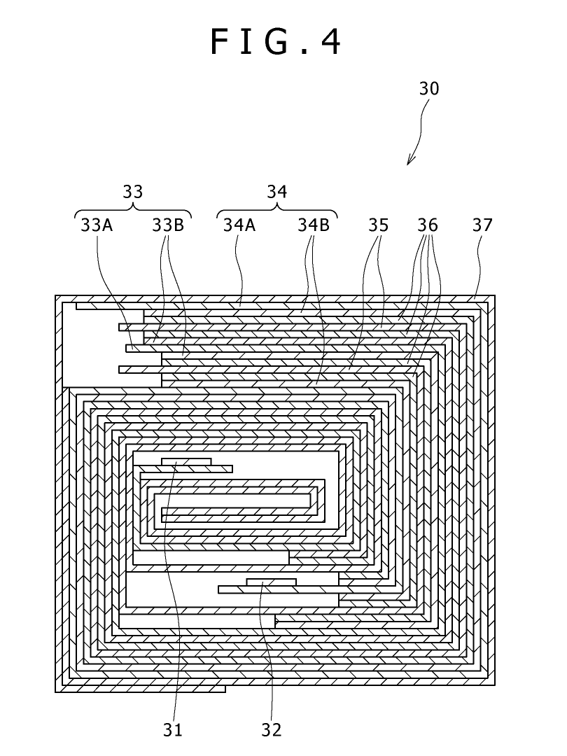

FIG. 4 is a sectional view, taken along line I-I of FIG. 3, of the wound electrode body 30 shown in FIG. 3. The wound electrode body 30 has a structure in which a positive electrode 33 and a negative electrode 34 are wound after being stacked, with a separator 35 and an electrolyte 36 therebetween. An outermost peripheral portion of the wound electrode body 30 is protected with a protective tape 37.

The positive electrode 33 has positive electrode active material layers 33B provided on both sides of a positive electrode current collector 33A. The negative electrode 34 has negative electrode active material layers 34B provided on both sides of a negative electrode current collector 34A, and is so disposed that each of its negative electrode active material layers 34B faces the positive electrode active material layer 33B. The configurations of the positive electrode current collector 33A, the positive electrode active material layer 33B, the negative electrode current collector 34A, the negative electrode active material layer 34B and the separator 35 are, for example, the same as the configurations described in the second to fourth embodiments above.

The electrolyte 36 includes the above-described electrolyte solution and the polymer holding the electrolyte solution, and is in a so-called gelled form. The electrolyte in the gelled form is preferable because a high ionic conductivity (for example, not less than 1 mS/cm at room temperature) is thereby obtained and leakage of liquid is thereby prevented.

Examples of the polymer include polyacrylonitrile, polyvinylidene fluoride, polyvinylidene fluoride-polyhexafluoropyrene copolymer, polytetrafluoroethylene, polyhexafluoropropylene, polyethylene oxide, polypropylene oxide, polyphosphazene, polysiloxane, polyvinyl acetate, polyvinyl alcohol, polymethyl methacrylate, polyacrylic acid, polymethacrylic acid, styrene-butadiene rubber, nitrile-butadiene rubber, polystyrene, and polycarbonate, which may be used either singly or in mixture of two or more of them. Among these polymers, particularly preferred from the viewpoint of electrochemical stability are polyacrylonitrile, polyvinylidene fluoride, polyhexafluoropropylene, polyethylene oxide and the like. The content of the polymer in the electrolyte solution varies depending on the compatibility between them, but is preferably, for example, in the range of 5 to 50 wt. %.

The content of the electrolyte salt is the same as in the case where the electrolyte solution has been described above. It should be noted that the term “solvent” here is used in a broad concept which is not limited to liquid solvents but includes ionically conductive materials capable of effecting dissociation of the electrolyte salt. Therefore, where an ionically conductive polymer is used, the polymer also is included in the solvent.

Method of Fabricating Cell

The cell as above-described is fabricated, for example, in the following manner.

First, a precursor solution containing the electrolyte solution, the polymer and a mixed solvent is prepared, is applied to the positive electrode 33 and the negative electrode 34, and the mixed solvent is evaporated off, to form an electrolyte 36. Subsequently, the positive electrode lead 31 is attached to the positive electrode current collector 33A, and the negative electrode lead 32 is attached to the negative electrode current collector 34A.

Next, the positive electrode 33 and the negative electrode 34 provided thereon with the electrolyte 36 are stacked, with the separator 35 sandwiched therebetween, the thus stacked assembly is wound in the longitudinal direction thereof and the protective tape 37 is adhered to the outermost peripheral portion of the wound assembly, whereby the wound electrode body 30 is formed. Subsequently, for example, the wound electrode body 30 is sandwiched between the armor members 40, and outer edge portions of the armor members 40 are adhered to each other by fusing or the like, whereby the wound electrode body 30 is enclosed. In this case, the close-contact film 41 is inserted in each of gaps between the positive electrode lead 31 as well as the negative electrode lead 32 and the armor members 40. By these steps, the cell as shown in FIGS. 3 and 4 can be obtained.

Besides, this cell may also be fabricated in the following manner.

First, the positive electrode lead 31 and the negative electrode lead 32 are attached respectively to the positive electrode 33 and the negative electrode 34, then the positive electrode 33 and the negative electrode 34 are stacked and wound, with the separator 35 sandwiched therebetween, and the protective tape 37 is adhered to an outermost peripheral portion of the wound assembly. By these steps, a wound body as a precursor of a wound electrode body 30 is formed.

Next, the wound body is clamped between the armor members 40, and outer peripheral edges of the armor members 40 exclusive of outer peripheral edges on one edge side are adhered to each other by fusing or the like, whereby the wound body is accommodated in the inside of the now bag-formed armor members 40. Then, an electrolyte composition containing the electrolyte solution, a monomer or monomers as raw material(s) for the polymer, a polymerization initiator and, optionally, other materials such as a polymerization inhibitor is prepared. The electrolyte composition is poured into the inside of the bag-formed armor members 40, and an opening portion of the bag-formed armor members 40 is sealed off by fusing or the like. Finally, thermopolymerization of the monomer(s) is conducted to form the polymer, thereby forming a gelled electrolyte 36. By these steps, the cell as shown in FIGS. 3 and 4 can be obtained.

Further, this cell may also be fabricated in the following manner.

First, the positive electrode lead 31 and the negative electrode lead 32 are attached to the positive electrode 33 and the negative electrode 34, respectively. Next, the positive electrode 33 and the negative electrode 34 are stacked and wound, in the condition where the separator 35 coated on its both sides with the polymer is sandwiched between the electrodes, and the protective tape 37 is adhered to an outermost peripheral portion of the thus stacked assembly, to form the wound electrode body 30.

Examples of the polymer include polymers (namely, homopolymers), copolymers and multi-component copolymers containing vinylidene fluoride or the like as a component. Specific examples of the bipolymer include polyvinylidene fluoride, a binary copolymer having vinylidene fluoride and hexafluoropropylene as components, and a ternary copolymer (terpolymer) having vinylidene fluoride, hexafluoropropylene and chlorotrifluoroethylene as components. Incidentally, the polymer may contain other polymer or polymers, together with the just-mentioned polymer having vinylidene fluoride as a component.

Subsequently, the above-mentioned electrolyte solution is poured into the inside of the armor members 40, and an opening portion of the armor members 40 is sealed off by fusing or the like. Finally, heating is conducted while applying a load on the armor members 40, whereby the separator 35 is brought into secure contact with the positive electrode 33 and the negative electrode 34 by way of the polymer therebetween. This results in that the polymer is impregnated with the electrolyte solution, and the polymer is gelled, to form the electrolyte 36. By these steps, the cell as shown in FIGS. 3 and 4 can be obtained.

Effect

The cell according to the fifth embodiment has an effect identical or similar to those of the cells according to the second, third or fourth embodiment of the application.

### 6. Sixth Embodiment

A cell according to a sixth embodiment will be described. The cell according to the sixth embodiment of the application is the same as the cell according to the fifth embodiment, except that the electrolyte solution is used as it is in place of the member (electrolyte 36) obtained by holding the electrolyte solution by the polymer. Therefore, the following detailed description of the configuration of the cell according to the sixth embodiment will be made chiefly of the difference from the fifth embodiment.

### Configuration of Cell

In the cell according to the sixth embodiment, the electrolyte solution is used in place of the gelled electrolyte 36. Accordingly, the wound electrode body 30 has a configuration in which the electrolyte 36 is omitted and the separator 35 is impregnated with the electrolyte solution.

Method of Fabricating Cell

This cell is fabricated, for example, in the following manner. First, a positive electrode composition is prepared, for example, by mixing a positive electrode active material, a binder and a conductive agent, and the composition is dispersed in a solvent such as N-methyl-2-pyrrolidone, to produce a positive electrode composition slurry. Next, the positive electrode composition slurry is applied to both sides of the positive electrode current collector 33A, followed by drying and compression molding to form the positive electrode active material layers 33B, whereby the positive electrode 33 is produced. Subsequently, for example, the positive electrode lead 31 is bonded to the positive electrode current collector 33A by, for example, ultrasonic welding, spot welding or the like.

Besides, a negative electrode composition is prepared, for example, by mixing a negative electrode material and a binder, and the composition is dispersed in a solvent such as N-methyl-2-pyrrolidone, to produce a negative electrode composition slurry. Next, the negative electrode composition slurry is applied to both sides of the negative electrode current collector 34A, followed by drying and compression molding to form the negative electrode active material layers 34B, whereby the negative electrode 34 is produced. Then, for example, the negative electrode lead 32 is bonded to the negative electrode current collector 34A by, for example, ultrasonic welding, spot welding or the like.

Subsequently, the positive electrode 33 and the negative electrode 34 are stacked, with the separator 35 sandwiched therebetween, the thus stacked assembly is wound, the wound assembly is sandwiched in the inside of the armor members 40, the electrolyte solution is poured into the inside of the armor members 40, and the armor members 40 are sealed off. By these steps, the cell as shown in FIGS. 3 and 4 can be obtained.

Effect

The cell according to the sixth embodiment has an effect identical or similar to those of the cells according to the second, third or fourth embodiment of the application.

### Examples

Now, the present application will be specifically described by showing Examples, which are not to be limitative of the application.

Samples 1-1 to 1-18

Sample 1-1

A cylindrical secondary cell as shown in FIGS. 1 and 2 was fabricated. First, 94 parts by mass (hereinafter referred to as parts by weight) of lithium cobaltate (LiCoO₂) powder as a positive electrode active material, 3 parts by weight of Ketchen black (amorphous carbon powder) as a conductive agent and 3 parts by weight of polyvinylidene fluoride as a binder were mixed together, and the resulting mixture was dispersed in N-methyl-2-pyrrolidone serving as a solvent, to form a positive electrode composition slurry. Next, the positive electrode composition slurry was uniformly applied to both sides of a positive electrode current collector 21A composed of a belt-like aluminum foil having a thickness of 20 μm, followed by drying and compression molding to form positive electrode active material layers 21B, thereby producing a positive electrode 21. Thereafter, an aluminum-made positive electrode lead 25 was attached to one end of the positive electrode current collector 21A.

Besides, 95 parts by weight of artificial graphite powder having an average particle diameter of 30 μm as a negative electrode active material and 5 parts by weight of polyvinylidene fluoride were mixed, and the resulting mixture was dispersed in N-methyl-2-pyrrolidone serving as a solvent, to form a negative electrode composition slurry. Thereafter, the negative electrode composition slurry was uniformly applied to both sides of a negative electrode current collector 22A composed of a belt-like copper foil having a thickness of 15 μm, followed by drying and compression molding to form negative electrode active material layers 22B, thereby producing a negative electrode 22. Subsequently, a nickel-made negative electrode lead 26 was attached to one end of the negative electrode current collector 22A.

After the positive electrode 21 and the negative electrode 22 were produced as above, a separator 23 composed of a microporous membrane was prepared. The negative electrode 22, the separator 23, the positive electrode 21 and the separator 23 were stacked in this order, and the thus stacked assembly was spirally wound a large number of times, thereby forming a jelly roll type wound electrode body 20 having an outside diameter of 17.5 mm.

After the wound electrode body 20 was thus produced, the wound electrode body 20 was clamped between a pair of insulating plates 12 and 13, the negative electrode lead 26 was welded to a cell can 11 formed of nickel-plated iron, whereas the positive electrode lead 25 was welded to a safety valve mechanism 15, and the wound electrode body 20 in this condition was accommodated into the inside of the cell can 11. Subsequently, an electrolyte solution was poured into the inside of the cell can 11 by a vacuum system.

Thereafter, a cell cap 14 was caulked to the cell can 11, with a gasket 17 therebetween, to produce a cylindrical secondary cell (secondary cell as Sample 1-1) having a diameter of 18 mm and a height of 16 mm.

Incidentally, the electrolyte solution was prepared in the following manner. First, a mixed solvent was prepared by mixing dimethyl carbonate (DMC), diethyl carbonate (DEC) and ethylene carbonate (EC) in a volume ratio of 5:1:4. In the mixed solvent, LiPF₆ as an electrolyte salt was dissolved in a concentration of 1 mol/l. To the solution thus obtained, 1 wt. % of vinylene carbonate (VC) was added, and 0.001 wt. % of N-methylbis((trifluoromethyl)sulfonyl)imide represented by the formula (4) was added as an additive.

Sample 1-2

A secondary cell as Sample 1-2 was fabricated in the same manner as Sample 1-1, except that the N-methylbis((trifluoromethyl)sulfonyl)imide of the above formula (4) was added as an additive to the mixed solvent in an amount of 0.02 wt. %.

Sample 1-3

A secondary cell as Sample 1-3 was fabricated in the same manner as Sample 1-1, except that the N-methylbis((trifluoromethyl)sulfonyl)imide of the formula (4) was added as an additive to the mixed solvent in an amount of 0.5 wt. %.

Sample 1-4

A secondary cell as Sample 1-4 was fabricated in the same manner as Sample 1-1, except that the N-methylbis((trifluoromethyl)sulfonyl)imide of the formula (4) was added as an additive to the mixed solvent in an amount of 1 wt. %.

Sample 1-5

A secondary cell as Sample 1-5 was fabricated in the same manner as Sample 1-1, except that the N-methylbis((trifluoromethyl)sulfonyl)imide of the formula (4) was added as an additive to the mixed solvent in an amount of 2 wt. %.

Sample 1-6

A secondary cell as Sample 1-6 was fabricated in the same manner as Sample 1-1, except that the N-methylbis((trifluoromethyl)sulfonyl)imide of the formula (4) was added as an additive to the mixed solvent in an amount of 5 wt. %.

Sample 1-7>

A secondary cell as Sample 1-7 was fabricated in the same manner as Sample 1-1, except that the N-methylbis((trifluoromethyl)sulfonyl)imide of the formula (4) was added as an additive to the mixed solvent in an amount of 0.0005 wt. %.

Sample 1-8

A secondary cell as Sample 1-8 was fabricated in the same manner as Sample 1-1, except that the N-methylbis((trifluoromethyl)sulfonyl)imide of the formula (4) was added as an additive to the mixed solvent in an amount of 8 wt. %.

Sample 1-9

A secondary cell as Sample 1-9 was fabricated in the same manner as Sample 1-1, except that 0.02 wt. % of N-ethylbis((trifluoromethyl)sulfonyl)imide represented by the above formula (5) was added as an additive to the mixed solvent.

Sample 1-10

A secondary cell as Sample 1-10 was fabricated in the same manner as Sample 1-1, except that 0.02 wt. % of N-propylbis((trifluoromethyl)sulfonyl)imide represented by the above formula (6) was added as an additive to the mixed solvent.

Sample 1-11

A secondary cell as Sample 1-11 was fabricated in the same manner as Sample 1-1, except that 0.02 wt. % of N-methylbis((pentafluoroethyl)sulfonyl)imide represented by the above formula (7) was added as an additive to the mixed solvent.

Sample 1-12

A secondary cell as Sample 1-12 was fabricated in the same manner as Sample 1-1, except that 0.02 wt. % of N-ethylbis((pentafluoroethyl)sulfonyl)imide represented by the above formula (8) was added as an additive to the mixed solvent.

Sample 1-13

A secondary cell as Sample 1-13 was fabricated in the same manner as Sample 1-1, except that 0.02 wt. % of N-trifluoromethylbis((trifluoromethyl)sulfonyl)imide represented by the above formula (9) was added as an additive to the mixed solvent.

Sample 1-14

A secondary cell as Sample 1-14 was fabricated in the same manner as Sample 1-1, except that 0.02 wt. % of N-methoxybis((trifluoromethyl)sulfonyl)imide represented by the above formula (10) was added as an additive to the mixed solvent.

Sample 1-15

A secondary cell as Sample 1-15 was fabricated in the same manner as Sample 1-1, except that 0.02 wt. % of N-ethoxybis((trifluoromethyl)sulfonyl)imide represented by the above formula (11) was added as an additive to the mixed solvent.

Sample 1-16

A secondary cell as Sample 1-16 was fabricated in the same manner as Sample 1-1, except that the N-methylbis((trifluoromethyl)sulfonyl)imide of the above formula (4) was not added as an additive to the mixed solvent.

Sample 1-17

A secondary cell as Sample 1-17 was fabricated in the same manner as Sample 1-1, except that 0.02 wt. % of triethanolamine represented by the following formula (20) was added as an additive to the mixed solvent.

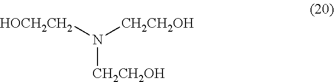

Sample 1-18

A secondary cell as Sample 1-18 was fabricated in the same manner as Sample 1-1, except that 0.02 wt. % of triethylamine represented by the following formula (21) was added as an additive to the mixed solvent.

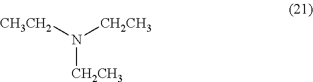

Samples 1-1 to 1-18 fabricated as above were served to the following high-temperature preservation test and cycle test.

High-Temperature Preservation Test

Each of the secondary cells fabricated as above was subjected to 2 cycles of charging and discharging at 23° C., was then again charged, and was left to stand in a thermostat at 60° C. for 30 days. Then, each secondary cell was again discharged, and the capacity recovery factor of the secondary cell was determined from the ratio of the discharge capacity after preservation to the discharge capacity before the preservation, according to the following formula.

Capacity recovery factor={(Discharge capacity after preservation)/(Discharge capacity before preservation)}×100(%)

Incidentally, the charging was carried out by a method in which constant-current charging at 1680 mA is performed until the cell voltage reaches 4.20 V, and then constant-voltage charging at 4.20 V is conducted until the total charging time reaches 4 hours. The discharging was carried out by a method in which constant-current discharging at 1200 mA is performed until the cell voltage is lowered to 2.5 V. Besides, the discharge capacity before preservation is the discharge capacity at the second cycle, and the discharge capacity after preservation is the discharge capacity immediately upon the preservation; in other words, the discharge capacity after preservation is the discharge capacity at the third cycle.

Cycle Test

Each of the secondary cells fabricated as above was subjected to charging and discharging at 23° C., and was thereby evaluated as to cycle characteristic. The charging was carried out by a method in which constant-current charging at 1680 mA is performed until the cell voltage reaches 4.20 V, and then constant-voltage charging at 4.20 V is conducted until the total charging time reaches 4 hours. The discharging was carried out by a method in which constant-current discharging at 1200 mA is performed until the cell voltage is lowered to 2.5 V. Such charging and discharging were repeated, and discharge capacity retention was determined from the ratio of the discharge capacity at the 300th cycle to the discharge capacity at the second cycle, according to the following formula.

Discharge capacity retention={(Discharge capacity at 300th cycle)/(Discharge capacity at second cycle)}×100(%)

The cycle characteristic of the secondary cell was evaluated in terms of the discharge capacity retention.

Test results for Samples 1-1 to 1-18 are shown in Table 1 below.

In Table 1, AG stands for artificial graphite; N-MTFMSI stands for N-methylbis((trifluoromethyl)sulfonyl)imide; N-ETFMSI stands for N-ethylbis((trifluoromethyl)sulfonyl)imide; N-PTFMSI stands for N-propylbis((trifluoromethyl)sulfonyl)imide; N-MPFESI stands for N-methylbis((pentafluoroethyl)sulfonyl)imide; N-EPFESI stands for N-ethylbis((pentafluoroethyl)sulfonyl)imide; N-TFMTFMSI stands for N-trifluoromethylbis((trifluoromethyl)sulfonyl)imide; N-MXTFMSI stands for N-methoxybis((trifluoromethyl)sulfonyl)imide; and N-EXTFMSI stands for N-ethoxybis((trifluoromethyl)sulfonyl)imide.

TABLE 1

| | | | Electrolyte solution | | | | | | | | | Amt of | Cap. | Cap. | Chrg. |
|---|---|---|---|---|---|---|---|---|---|---|---|---|---|---|---|
| | Positive | Neg. | | | Mixed | | | Volume | | | | additive | rec. | ret. | volt. |
| Sample | electrode | electrode | Kind | Kind | solvent | | | ratio | Kind | wt. % | Additive | wt. % | [%] | [%] | [V] |
| 1-1 | LiCoO₂ | AG | LiPF₆: | — | DMC | DEC | EC | 5:1:4 | VC | 1 | N-MTFMSI | 0.001 | 82 | 80 | 4.20 |
| | | | 1.0 mol/l | | | | | | | | | | | | |
| 1-2 | LiCoO₂ | AG | LiPF₆: | — | DMC | DEC | EC | 5:1:4 | VC | 1 | N-MTFMSI | 0.02 | 87 | 82 | 4.20 |
| | | | 1.0 mol/l | | | | | | | | | | | | |
| 1-3 | LiCoO₂ | AG | LiPF₆: | — | DMC | DEC | EC | 5:1:4 | VC | 1 | N-MTFMSI | 0.5 | 85 | 84 | 4.20 |
| | | | 1.0 mol/l | | | | | | | | | | | | |
| 1-4 | LiCoO₂ | AG | LiPF₆: | — | DMC | DEC | EC | 5:1:4 | VC | 1 | N-MTFMSI | 1 | 84 | 84 | 4.20 |
| | | | 1.0 mol/l | | | | | | | | | | | | |
| 1-5 | LiCoO₂ | AG | LiPF₆: | — | DMC | DEC | EC | 5:1:4 | VC | 1 | N-MTFMSI | 2 | 83 | 81 | 4.20 |
| | | | 1.0 mol/l | | | | | | | | | | | | |
| 1-6 | LiCoO₂ | AG | LiPF₆: | — | DMC | DEC | EC | 5:1:4 | VC | 1 | N-MTFMSI | 5 | 82 | 79 | 4.20 |
| | | | 1.0 mol/l | | | | | | | | | | | | |
| 1-7 | LiCoO₂ | AG | LiPF₆: | — | DMC | DEC | EC | 5:1:4 | VC | 1 | N-MTFMSI | 0.0005 | 78 | 75 | 4.20 |
| | | | 1.0 mol/l | | | | | | | | | | | | |
| 1-8 | LiCoO₂ | AG | LiPF₆: | — | DMC | DEC | EC | 5:1:4 | VC | 1 | N-MTFMSI | 8 | 70 | 69 | 4.20 |
| | | | 1.0 mol/l | | | | | | | | | | | | |
| 1-9 | LiCoO₂ | AG | LiPF₆: | — | DMC | DEC | EC | 5:1:4 | VC | 1 | N-ETFMSI | 0.02 | 87 | 82 | 4.20 |
| | | | 1.0 mol/l | | | | | | | | | | | | |
| 1-10 | LiCoO₂ | AG | LiPF₆: | — | DMC | DEC | EC | 5:1:4 | VC | 1 | N-PTFMSI | 0.02 | 85 | 80 | 4.20 |
| | | | 1.0 mol/l | | | | | | | | | | | | |
| 1-11 | LiCoO₂ | AG | LiPF₆: | — | DMC | DEC | EC | 5:1:4 | VC | 1 | N-MPFESI | 0.02 | 85 | 79 | 4.20 |
| | | | 1.0 mol/l | | | | | | | | | | | | |
| 1-12 | LiCoO₂ | AG | LiPF₆: | — | DMC | DEC | EC | 5:1:4 | VC | 1 | N-EPFESI | 0.02 | 84 | 79 | 4.20 |
| | | | 1.0 mol/l | | | | | | | | | | | | |
| 1-13 | LiCoO₂ | AG | LiPF₆: | — | DMC | DEC | EC | 5:1:4 | VC | 1 | N-TFMTFMSI | 0.02 | 86 | 78 | 4.20 |
| | | | 1.0 mol/l | | | | | | | | | | | | |
| 1-14 | LiCoO₂ | AG | LiPF₆: | — | DMC | DEC | EC | 5:1:4 | VC | 1 | N-MXTFMSI | 0.02 | 84 | 78 | 4.20 |
| | | | 1.0 mol/l | | | | | | | | | | | | |
| 1-15 | LiCoO₂ | AG | LiPF₆: | — | DMC | DEC | EC | 5:1:4 | VC | 1 | N-EXTFMSI | 0.02 | 83 | 78 | 4.20 |
| | | | 1.0 mol/l | | | | | | | | | | | | |
| 1-16 | LiCoO₂ | AG | LiPF₆: | — | DMC | DEC | EC | 5:1:4 | VC | 1 | none | — | 78 | 75 | 4.20 |
| | | | 1.0 mol/l | | | | | | | | | | | | |
| 1-17 | LiCoO₂ | AG | LiPF₆: | — | DMC | DEC | EC | 5:1:4 | VC | 1 | Triethanol- | 0.02 | 79 | 76 | 4.20 |
| | | | 1.0 mol/l | | | | | | | | amine | | | | |
| 1-18 | LiCoO₂ | AG | LiPF₆: | — | DMC | DEC | EC | 5:1:4 | VC | 1 | Triethyl- | 0.02 | 79 | 75 | 4.20 |
| | | | 1.0 mol/l | | | | | | | | amine | | | | |

Cap. rec.: Capacity recovery factor after preservation at 60° C. for one month
Cap. ret.: Capacity retention after 300 cycles
Chrg. volt.: Charging voltage

Evaluation

As shown in Table 1, Samples 1-1 to 1-6 and Samples 1-9 to 1-15 were better than Sample 1-16 in cycle characteristic and high-temperature preservability. In addition, Samples 1-1 to 1-6 and Samples 1-9 to 1-15 were better than Samples 1-17 and 1-18 in cycle characteristic and high-temperature preservability. In other words, it was verified that good cycle characteristic and high-temperature preservability can be obtained by addition of any of the alkanamine derivatives as represented by the above formulas (4) to (11). Besides, by comparison of Samples 1-1 to 1-8, it was confirmed that an optimum addition amount of the alkanamine derivative represented by the formula (4) is in the range of 0.001 to 5 wt. % based on the total amount of the electrolyte solution.

Samples 1-19 and 1-20

Sample 1-19

A secondary cell as Sample 1-19 was fabricated in the same manner as Sample 1-1, except that a mixed solvent was prepared by mixing dimethyl carbonate (DMC), 4-fluoro-1,3-dioxolan-2-one (FEC) and ethylene carbonate (EC) in a volume ratio of 6:2:2.

Sample 1-20

A secondary cell as Sample 1-20 was fabricated in the same manner as Sample 1-19, except that the N-methylbis((trifluoromethyl)sulfonyl)imide represented by the above formula (4) was not added as an additive to the mixed solvent.

The secondary cells as Samples 1-19 and 1-20 were served to the high-temperature preservation test and the cycle test. The test results are shown in Table 2 below.

In Table 2, N-MTFMSI stands for N-methylbis((trifluoromethyl)sulfonyl)imide.

TABLE 2

| | | | Electrolyte solution | | | | | | | | | Amt of | Cap. | Cap. | |
|---|---|---|---|---|---|---|---|---|---|---|---|---|---|---|---|
| | Positive | Neg. | | | Mixed | | | Volume | | | | additive wt. | rec. | ret. | Chrg. volt. |
| Sample | electrode | electrode | Kind | Kind | solvent | | | ratio | Kind | wt. % | Additive | % | [%] | [%] | [V] |
| 1-19 | LiCoO₂ | AG | LiPF₆: | — | DMC | FEC | EC | 6:2:2 | VC | 1 | N-MTFMSI | 0.02 | 87 | 86 | 4.20 |
| | | | 1.0 mol/l | | | | | | | | | | | | |
| 1-20 | LiCoO₂ | AG | LiPF₆: | — | DMC | FEC | EC | 6:2:2 | VC | 1 | none | — | 80 | 78 | 4.20 |
| | | | 1.0 mol/l | | | | | | | | | | | | |

Evaluation

As shown in Table 2, Sample 1-19 was better than Sample 1-20 in high-temperature preservability and cycle characteristic. In other words, it was found that in the case where a solvent containing 4-fluoro-1,3-dioxolan-2-one (FEC) is used, good high-temperature preservability and cycle characteristic can be obtained by addition of the alkanamine derivative as represented by the above formula (4).

Samples 1-21 and 1-22

Sample 1-21

A secondary cell as Sample 1-21 was fabricated in the same manner as Sample 1-19, except that 0.1 mol/l of lithium bis(trifluoromethanesulfonyl)imide (LiTFSI) was further dissolved as an electrolyte salt in the mixed solvent.

Sample 1-22

A secondary cell as Sample 1-22 was fabricated in the same manner as Sample 1-21, except that the N-methylbis((trifluoromethyl)sulfonyl)imide was not added as an additive to the mixed solvent.

The secondary cells as Samples 1-21 and 1-22 were served to the high-temperature preservation test and the cycle test. The test results are shown in Table 3 below.

In Table 3, N-MTFMSI stands for N-methylbis((trifluoromethyl)sulfonyl)imide.

TABLE 3

| | | | Electrolyte solution | | | | | | | | | Amt of | Cap. | Cap. | |
|---|---|---|---|---|---|---|---|---|---|---|---|---|---|---|---|
| | Positive | Neg. | | | Mixed | | | Volume | | | | additive | rec. | ret. | Chrg. volt. |
| Sample | electrode | electrode | Kind | Kind | solvent | | | ratio | Kind | wt. % | Additive | wt. % | [%] | [%] | [V] |
| 1-21 | LiCoO₂ | AG | LiPF₆: | LiTFSI: | DMC | FEC | EC | 6:2:2 | VC | 1 | N-MTFMSI | 0.02 | 86 | 86 | 4.20 |
| | | | 1.0 mol/l | 0.1 mol/l | | | | | | | | | | | |
| 1-22 | LiCoO₂ | AG | LiPF₆: | LiTFSI: | DMC | FEC | EC | 6:2:2 | VC | 1 | none | — | 83 | 78 | 4.20 |
| | | | 1.0 mol/l | 0.1 mol/l | | | | | | | | | | | |

As shown in Table 3, Sample 1-21 was better than Sample 1-22 in high-temperature preservability and cycle characteristic. In other words, it was verified that in the case where LiTFSI is used as an electrolyte salt, good high-temperature preservability and cycle characteristic can be obtained by addition of the alkanamine derivative as represented by the above formula (4).

Samples 1-23 to 1-34

Sample 1-23

A secondary cell as Sample 1-23 was fabricated in the same manner as Sample 1-1, except that LiNiO2 powder was used as the positive electrode active material.

Sample 1-24

A secondary cell as Sample 1-24 was fabricated in the same manner as Sample 1-23, except that the N-methylbis((trifluoromethyl)sulfonyl)imide of the formula (4) was not added as an additive to the mixed solvent.

Sample 1-25

A secondary cell as Sample 1-25 was fabricated in the same manner as Sample 1-1, except that LiMn2O4 powder was used as the positive electrode active material.

Sample 1-26

A secondary cell as Sample 1-26 was fabricated in the same manner as Sample 1-25, except that the N-methylbis((trifluoromethyl)sulfonyl)imide of the formula (4) was not added as an additive to the mixed solvent.

Sample 1-27

A secondary cell as Sample 1-27 was fabricated in the same manner as Sample 1-1, except that LiCo0.50Ni0.50O2 powder was used as the positive electrode active material.

Sample 1-28

A secondary cell as Sample 1-28 was fabricated in the same manner as Sample 1-27, except that the N-methylbis((trifluoromethyl)sulfonyl)imide of the formula (4) was not added as an additive to the mixed solvent.

Sample 1-29

A secondary cell as Sample 1-29 was fabricated in the same manner as Sample 1-1, except that LiCo0.33Ni0.33Mn0.33O2 powder was used as the positive electrode active material.

Sample 1-30

A secondary cell as Sample 1-30 was fabricated in the same manner as Sample 1-29, except that the N-methylbis((trifluoromethyl)sulfonyl)imide of the formula (4) was not added as an additive to the mixed solvent.

Sample 1-31

A secondary cell as Sample 1-31 was fabricated in the same manner as Sample 1-1, except that LiFePO4 powder was used as the positive electrode active material.

Sample 1-32

A secondary cell as Sample 1-32 was fabricated in the same manner as Sample 1-31, except that the N-methylbis((trifluoromethyl)sulfonyl)imide of the formula (4) was not added as an additive to the mixed solvent.

Sample 1-33

A secondary cell as Sample 1-33 was fabricated in the same manner as Sample 1-1, except that LiFe0.50Mn0.50PO4 powder was used as the positive electrode active material.

Sample 1-34

A secondary cell as Sample 1-34 was fabricated in the same manner as Sample 1-33, except that the N-methylbis((trifluoromethyl)sulfonyl)imide of the formula (4) was not added as an additive to the mixed solvent.

Samples 1-23 to 1-34 were served to the high-temperature preservability test and the cycle test. The test results are shown in Table 4 below.

In Table 4, N-MTFMSI stands for N-methylbis((trifluoromethyl)sulfonyl)imide.

TABLE 4

| | | | Electrolyte solution | | | | | | | | | Amt of | Cap. | Cap. | Chrg. |
|---|---|---|---|---|---|---|---|---|---|---|---|---|---|---|---|
| Sam- | Positive | Neg. | | | Mixed | | | Volume | | wt. | | additive | rec. | ret. | volt. |
| ple | electrode | electrode | Kind | Kind | solvent | | | ratio | Kind | % | Additive | wt. % | [%] | [%] | [V] |
| 1-23 | LiNiO₂ | AG | LiPF₆: | — | DMC | DEC | EC | 5:1:4 | VC | 1 | N-MTFMSI | 0.02 | 84 | 82 | 4.20 |
| | | | 1.0 mol/l | | | | | | | | | | | | |
| 1-24 | LiNiO₂ | AG | LiPF₆: | — | DMC | DEC | EC | 5:1:4 | VC | 1 | none | — | 79 | 76 | 4.20 |
| | | | 1.0 mol/l | | | | | | | | | | | | |
| 1-25 | LiMn₂O₄ | AG | LiPF₆: | — | DMC | DEC | EC | 5:1:4 | VC | 1 | N-MTFMSI | 0.02 | 81 | 75 | 4.20 |
| | | | 1.0 mol/l | | | | | | | | | | | | |
| 1-26 | LiMn₂O₄ | AG | LiPF₆: | — | DMC | DEC | EC | 5:1:4 | VC | 1 | none | — | 78 | 70 | 4.20 |
| | | | 1.0 mol/l | | | | | | | | | | | | |
| 1-27 | LiCo_{0.50}Ni_{0.50}O₂ | AG | LiPF₆: | — | DMC | DEC | EC | 5:1:4 | VC | 1 | N-MTFMSI | 0.02 | 85 | 81 | 4.20 |
| | | | 1.0 mol/l | | | | | | | | | | | | |
| 1-28 | LiCo_{0.50}Ni_{0.50}O₂ | AG | LiPF₆: | — | DMC | DEC | EC | 5:1:4 | VC | 1 | none | — | 80 | 78 | 4.20 |
| | | | 1.0 mol/l | | | | | | | | | | | | |
| 1-29 | LiCo_{0.33}Ni_{0.33}Mn_{0.33}O₂ | AG | LiPF₆: | — | DMC | DEC | EC | 5:1:4 | VC | 1 | N-MTFMSI | 0.02 | 86 | 81 | 4.20 |
| | | | 1.0 mol/l | | | | | | | | | | | | |
| 1-30 | LiCo_{0.33}Ni_{0.33}Mn_{0.33}O₂ | AG | LiPF₆: | — | DMC | DEC | EC | 5:1:4 | VC | 1 | none | — | 83 | 78 | 4.20 |
| | | | 1.0 mol/l | | | | | | | | | | | | |
| 1-31 | LiFePO₄ | AG | LiPF₆: | — | DMC | DEC | EC | 5:1:4 | VC | 1 | N-MTFMSI | 0.02 | 87 | 80 | 4.20 |
| | | | 1.0 mol/l | | | | | | | | | | | | |
| 1-32 | LiFePO₄ | AG | LiPF₆: | — | DMC | DEC | EC | 5:1:4 | VC | 1 | none | — | 80 | 73 | 4.20 |
| | | | 1.0 mol/l | | | | | | | | | | | | |
| 1-33 | LiFe_{0.50}Mn_{0.50}PO₄ | AG | LiPF₆: | — | DMC | DEC | EC | 5:1:4 | VC | 1 | N-MTFMSI | 0.02 | 86 | 81 | 4.20 |
| | | | 1.0 mol/l | | | | | | | | | | | | |
| 1-34 | LiFe_{0.50}Mn_{0.50}PO₄ | AG | LiPF₆: | — | DMC | DEC | EC | 5:1:4 | VC | 1 | none | — | 83 | 75 | 4.20 |
| | | | 1.0 mol/l | | | | | | | | | | | | |

Evaluation

As shown in Table 4, Sample 1-23 was better than Sample 1-24 in high-temperature preservability and cycle characteristic. Sample 1-25 was better than Sample 1-26 in high-temperature preservability and cycle characteristic. Sample 1-27 was better than Sample 1-28 in high-temperature preservability and cycle characteristic. Sample 1-29 was better than Sample 1-30 in high-temperature preservability and cycle characteristic. Sample 1-31 was better than Sample 1-32 in high-temperature preservability and cycle characteristic. Sample 1-33 was better than Sample 1-34 in high-temperature preservability and cycle characteristic. In other words, it was verified that in the case where such a positive electrode active material as LiNiO₂, LiMn₂O₄, LiCo_{0.50}Ni_{0.50}O₂, LiCo_{0.33}Ni_{0.33}Mn_{0.33}O₂, and LiFe_{0.50}Mn_{0.50}PO₄ is used, good high-temperature preservability and cycle characteristic can be obtained by use of an electrolyte solution containing the alkanamine derivative as represented by the above formula (4).

Samples 1-35 to 1-44

Sample 1-35

A negative electrode 22 was produced in the following manner.

On a negative electrode current collector 22A composed of a 15 μm-thick copper foil, silicon (Si) was deposited by an electron beam evaporation method, to form negative electrode active material layers 22B.

A secondary cell as Sample 1-35 was fabricated in the same manner as Sample 1-1, except for the just-mentioned point.

Sample 1-36

A secondary cell as Sample 1-36 was fabricated in the same manner as Sample 1-35, except that the N-methylbis((trifluoromethyl)sulfonyl)imide of the formula (4) was not added as an additive to the mixed solvent.

Sample 1-37

A negative electrode 22 was produced in the following manner.

On a negative electrode current collector 22A composed of a 15 μm-thick copper foil, tin (Sn) was deposited by a vacuum evaporation method, to form negative electrode active material layers 22B.

A secondary cell as Sample 1-37 was fabricated in the same manner as Sample 1-1, except for the just-mentioned point.

Sample 1-38

A secondary cell as Sample 1-38 was fabricated in the same manner as Sample 1-37, except that the N-methylbis((trifluoromethyl)sulfonyl)imide of the formula (4) was not added as an additive to the mixed solvent.

Sample 1-39

A mixture of 50 parts by weight of Co—Si alloy powder having an average particle diameter of 10 μm as a negative electrode active material, 40 parts by weight of graphite having an average particle diameter of 15 μm, 5 parts by weight of Ketchen black and 5 parts by weight of polyvinylidene fluoride was dispersed in N-methyl-2-pyrrolidone used as a solvent, to prepare a negative electrode composition slurry.

A secondary cell as Sample 1-39 was fabricated in the same manner as Sample 1-1, except for the just-mentioned point.

Sample 1-40

A secondary cell as Sample 1-40 was fabricated in the same manner as Sample 1-39, except that the N-methylbis((trifluoromethyl)sulfonyl)imide of the formula (4) was not added as an additive to the mixed solvent.

Sample 1-41

A mixture of 50 parts by weight of Co—Sn alloy powder having an average particle diameter of 10 μm as a negative electrode active material, 40 parts by weight of graphite having an average particle diameter of 15 μm, 5 parts by weight of Ketchen black and 5 parts by weight of polyvinylidene fluoride was dispersed in N-methyl-2-pyrrolidone used as a solvent, to prepare a negative electrode composition slurry.

A second cell as Sample 1-41 was fabricated in the same manner as Sample 1-1, except for the just-mentioned point.

Sample 1-42

A secondary cell as Sample 1-42 was fabricated in the same manner as Sample 1-41, except that the N-methylbis((trifluoromethyl)sulfonyl)imide of the formula (4) was not added as an additive to the mixed solvent.

Sample 1-43

A negative electrode was produced in the following manner.

First, as raw material, Co—Sn alloy powder and carbon powder were mixed with each other in a predetermined ratio, and the powders were subjected to dry mixing in the condition where the total amount of powder was 10 g. The resulting mixture was set in a reaction vessel of a planetary ball mill produced by Ito Seisakusho Co., Ltd. together with 400 g of steel balls measuring 9 mm in diameter. After the inside of the reaction vessel was flushed with argon gas, a cycle including a rotating operation at 250 rpm for 10 minutes and a rest for 10 minutes was repeated until the total operation time reached 20 hours.

Thereafter, the reaction vessel was cooled to room temperature, and the negative electrode active material powder thus synthesized was served to composition analysis. As a result, it was found that the content of tin (Sn) was 49.5 wt. %, the content of cobalt (Co) was 29.7 wt. %, the content of carbon (C) was 19.8 wt. %, and the ratio Co/(Sn+Co) of the content of cobalt (Co) to the total content of tin (Sn) and cobalt (Co) was 37.5 wt. %. Incidentally, the content of carbon (C) was measured by a carbon-sulfur analyzer, whereas the contents of tin (Sn) and cobalt (Co) were measured by inductively coupled plasma (ICP)-atomic emission spectroscopy.

Next, a mixture of 80 parts by weight of the negative electrode active material powder, 11 parts by weight of graphite and 1 parts by weight of acetylene black as conductive agents, and 8 parts by eight of polyvinylidene fluoride as a binder was dispersed in N-methyl-2-pyrrolidone used as a solvent, to prepare a negative electrode composition slurry.

A secondary cell as Sample 1-43 was fabricated in the same manner as Sample 1-1, except for the just-mentioned points.

Sample 1-44

A secondary cell as Sample 1-44 was fabricated in the same manner as Sample 1-43, except that the N-methylbis((trifluoromethyl)sulfonyl)imide of the formula (4) was not added as an additive to the mixed solvent.

Samples 1-35 to 1-44 were served to the high-temperature preservation test and the cycle test. The test results are shown in Table 5 below.

In Table 5, N-MTFMSI stands for N-methylbis((trifluoromethyl)sulfonyl)imide.

TABLE 5

| | | | Electrolyte solution | | | | | | | | | Amt of | Cap. | Cap. | |
|---|---|---|---|---|---|---|---|---|---|---|---|---|---|---|---|
| | Positive | Neg. | | | Mixed | | | Volume | | | | additive wt. | rec. | ret. | Chrg. volt. |
| Sample | electrode | electrode | Kind | Kind | solvent | | | ratio | Kind | wt. % | Additive | % | [%] | [%] | [V] |
| 1-35 | LiCoO₂ | Si | LiPF₆: | — | DMC | DEC | EC | 5:1:4 | VC | 1 | N-MTFMSI | 0.02 | 81 | 76 | 4.20 |
| | | | 1.0 mol/l | | | | | | | | | | | | |
| 1-36 | LiCoO₂ | Si | LiPF₆: | — | DMC | DEC | EC | 5:1:4 | VC | 1 | none | — | 75 | 70 | 4.20 |
| | | | 1.0 mol/l | | | | | | | | | | | | |
| 1-37 | LiCoO₂ | Sn | LiPF₆: | — | DMC | DEC | EC | 5:1:4 | VC | 1 | N-MTFMSI | 0.02 | 80 | 72 | 4.20 |
| | | | 1.0 mol/l | | | | | | | | | | | | |
| 1-38 | LiCoO₂ | Sn | LiPF₆: | — | DMC | DEC | EC | 5:1:4 | VC | 1 | none | — | 76 | 65 | 4.20 |
| | | | 1.0 mol/l | | | | | | | | | | | | |
| 1-39 | LiCoO₂ | Co—Si | LiPF₆: | — | DMC | DEC | EC | 5:1:4 | VC | 1 | N-MTFMSI | 0.02 | 76 | 83 | 4.20 |
| | | | 1.0 mol/l | | | | | | | | | | | | |
| 1-40 | LiCoO₂ | Co—Si | LiPF₆: | — | DMC | DEC | EC | 5:1:4 | VC | 1 | none | — | 70 | 75 | 4.20 |
| | | | 1.0 mol/l | | | | | | | | | | | | |
| 1-41 | LiCoO₂ | Co—Sn | LiPF₆: | — | DMC | DEC | EC | 5:1:4 | VC | 1 | N-MTFMSI | 0.02 | 85 | 81 | 4.20 |
| | | | 1.0 mol/l | | | | | | | | | | | | |
| 1-42 | LiCoO₂ | Co—Sn | LiPF₆: | — | DMC | DEC | EC | 5:1:4 | VC | 1 | none | — | 80 | 75 | 4.20 |
| | | | 1.0 mol/l | | | | | | | | | | | | |
| 1-43 | LiCoO₂ | CoSnC- | LiPF₆: | — | DMC | DEC | EC | 5:1:4 | VC | 1 | N-MTFMSI | 0.02 | 85 | 86 | 4.20 |
| | | containing | 1.0 mol/l | | | | | | | | | | | | |
| | | material | | | | | | | | | | | | | |
| 1-44 | LiCoO₂ | CoSnC- | LiPF₆: | — | DMC | DEC | EC | 5:1:4 | VC | 1 | none | — | 80 | 80 | 4.20 |
| | | containing | 1.0 mol/l | | | | | | | | | | | | |
| | | material | | | | | | | | | | | | | |

Evaluation

As shown in Table 5, Sample 1-35 was better than Sample 1-36 in high-temperature preservability and cycle characteristic. Sample 1-37 was better than Sample 1-38 in high-temperature preservability and cycle characteristic. Sample 1-39 was better than Sample 1-40 in high-temperature preservability and cycle characteristic. Sample 1-41 was better than Sample 1-42 in high-temperature preservability and cycle characteristic. Sample 1-43 was better than Sample 1-44 in high-temperature preservability and cycle characteristic. In other words, it was verified that in the case where such a negative electrode material as silicon, tin, Co—Si alloy powder, Co—Sn alloy powder, and a CoSnC-containing material is used, good high-temperature preservability and cycle characteristic can be obtained by use of an electrolyte solution containing the alkanamine derivative as represented by the above formula (4).

Samples 1-45 to 1-50

Sample 1-45

A secondary cell as Sample 1-45 was fabricated in the same manner as Sample 1-1, except that the cell was designed to have an open-circuit voltage in a fully charged state of 4.30 V, by controlling the quantity of the positive electrode active material and the quantity of the negative electrode active material.

Sample 1-46

A secondary cell as Sample 1-46 was fabricated in the same manner as Sample 1-45, except that the N-methylbis((trifluoromethyl)sulfonyl)imide of the formula (4) was not added as an additive to the mixed solvent.

Sample 1-47

A secondary cell as Sample 1-47 was fabricated in the same manner as Sample 1-1, except that the cell was designed to have an open-circuit voltage in a fully charged state of 4.35 V, by controlling the quantity of the positive electrode active material and the quantity of the negative electrode active material.

Sample 1-48

A secondary cell as Sample 1-48 was fabricated in the same manner as Sample 1-47, except that the N-methylbis((trifluoromethyl)sulfonyl)imide of the formula (4) was not added as an additive to the mixed solvent.

Sample 1-49

A secondary cell as Sample 1-49 was fabricated in the same manner as Sample 1-1, except that the cell was designed to have an open-circuit voltage in a fully charged state of 4.40 V, by controlling the quantity of the positive electrode active material and the quantity of the negative electrode active material.

Sample 1-50

A secondary cell as Sample 1-50 was fabricated in the same manner as Sample 1-49, except that the N-methylbis((trifluoromethyl)sulfonyl)imide of the formula (4) was not added as an additive to the mixed solvent.

Samples 1-45 to 1-50 were served to the high-temperature preservation test and the cycle test. In the high-temperature preservation test and the cycle test, the charging voltage for the Samples 1-45 and 1-46 was set at 4.30 V, while the charging voltage for the Samples 1-47 and 1-48 was set at 4.35 V, and the charging voltage for the Samples 1-49 and 1-50 was set at 4.40 V. The test results are shown in Table 6 below.

In Table 6, N-MTFMSI stands for N-methylbis((trifluoromethyl)sulfonyl)imide.

TABLE 6

| | | | Electrolyte solution | | | | | | | | | Amt of | Cap. | Cap. | |
|---|---|---|---|---|---|---|---|---|---|---|---|---|---|---|---|
| | Positive | Neg. | | | Mixed | | | Volume | | | | additive wt. | rec. | ret. | Chrg. volt. |
| Sample | electrode | electrode | Kind | Kind | solvent | | | ratio | Kind | wt. % | Additive | % | [%] | [%] | [V] |
| 1-45 | LiCoO₂ | AG | LiPF₆: | — | DMC | DEC | EC | 5:1:4 | VC | 1 | N-MTFMSI | 0.02 | 78 | 70 | 4.30 |
| | | | 1.0 mol/l | | | | | | | | | | | | |
| 1-46 | LiCoO₂ | AG | LiPF₆: | — | DMC | DEC | EC | 5:1:4 | VC | 1 | none | — | 74 | 65 | 4.30 |
| | | | 1.0 mol/l | | | | | | | | | | | | |
| 1-47 | LiCoO₂ | AG | LiPF₆: | — | DMC | DEC | EC | 5:1:4 | VC | 1 | N-MTFMSI | 0.02 | 75 | 60 | 4.35 |
| | | | 1.0 mol/l | | | | | | | | | | | | |
| 1-48 | LiCoO₂ | AG | LiPF₆: | — | DMC | DEC | EC | 5:1:4 | VC | 1 | none | — | 69 | 40 | 4.35 |
| | | | 1.0 mol/l | | | | | | | | | | | | |
| 1-49 | LiCoO₂ | AG | LiPF₆:. | — | DMC | DEC | EC | 5:1:4 | VC | 1 | N-MTFMSI | 0.02 | 72 | 50 | 4.40 |
| | | | 1.0 mol/l | | | | | | | | | | | | |
| 1-50 | LiCoO₂ | AG | LiPF₆: | — | DMC | DEC | EC | 5:1:4 | VC | 1 | none | — | 65 | 10 | 4.40 |
| | | | 1.0 mol/l | | | | | | | | | | | | |

As shown in Table 6, Sample 1-45 was better than Sample 1-46 in high-temperature preservability and cycle characteristic. Sample 1-47 was better than Sample 1-48 in high-temperature preservability and cycle characteristic. Sample 1-49 was better than Sample 1-50 in high-temperature preservability and cycle characteristic. In other words, it was found that in the case where the charging voltage is set at a value of not less than 4.30 V, good high-temperature preservability and cycle characteristic can be obtained by using an electrolyte solution containing the alkanamine derivative as represented by the above formula (4).

Samples 2-1 to 2-16

Sample 2-1

A secondary cell as Sample 2-1 was fabricated in the same manner as Sample 1-1, except that 0.001 wt. % of N-methylbis(trifluoromethoxysulfinyl)imide represented by the above formula (12) was added as an additive to the mixed solvent.

Sample 2-2

A secondary cell as Sample 2-2 was fabricated in the same manner as Sample 2-1, except that the N-methylbis(trifluoromethoxysulfinyl)imide of the formula (12) was added as an additive to the mixed solvent in an amount of 0.02 wt. %.

Sample 2-3

A secondary cell as Sample 2-3 was fabricated in the same manner as Sample 2-1, except that the N-methylbis(trifluoromethoxysulfinyl)imide of the formula (12) was added as an additive to the mixed solvent in an amount of 0.5 wt. %.

Sample 2-4

A secondary cell as Sample 2-4 was fabricated in the same manner as Sample 2-1, except that the N-methylbis(trifluoromethoxysulfinyl)imide of the formula (12) was added as an additive to the mixed solvent in an amount of 1 wt. %.

Sample 2-5

A secondary cell as Sample 2-5 was fabricated in the same manner as Sample 2-1, except that the N-methylbis(trifluoromethoxysulfinyl)imide of the formula (12) was added as an additive to the mixed solvent in an amount of 2 wt. %.

Sample 2-6

A secondary cell as Sample 2-6 was fabricated in the same manner as Sample 2-1, except that the N-methylbis(trifluoromethoxysulfinyl)imide of the formula (12) was added as an additive to the mixed solvent in an amount of 5 wt. %.

Sample 2-7

A secondary cell as Sample 2-7 was fabricated in the same manner as Sample 2-1, except that the N-methylbis(trifluoromethoxysulfinyl)imide of the formula (12) was added as an additive to the mixed solvent in an amount of 0.0005 wt. %.

Sample 2-8

A secondary cell as Sample 2-8 was fabricated in the same manner as Sample 2-1, except that the N-methylbis(trifluoromethoxysulfinyl)imide of the formula (12) was added as an additive to the mixed solvent in an amount of 8 wt. %.

Sample 2-9

A secondary cell as Sample 2-9 was fabricated in the same manner as Sample 2-1, except that 0.02 wt. % of N-ethylbis(trifluoromethoxysulfinyl)imide represented by the above formula (13) was added as an additive to the mixed solvent.

Sample 2-10

A secondary cell as Sample 2-10 was fabricated in the same manner as Sample 2-1, except that 0.02 wt. % of N-propylbis(trifluoromethoxysulfinyl)imide represented by the above formula (14) was added as an additive to the mixed solvent.

Sample 2-11

A secondary cell as Sample 2-11 was fabricated in the same manner as Sample 2-1, except that 0.02 wt. % of N-methylbis(pentafluoroethoxysulfinyl)imide represented by the above formula (15) was added as an additive to the mixed solvent.

Sample 2-12

A secondary cell as Sample 2-12 was fabricated in the same manner as Sample 2-1, except that 0.02 wt. % of N-ethylbis(pentafluoroethoxysulfinyl)imide represented by the above formula (16) was added as an additive to the mixed solvent.

Sample 2-13

A secondary cell as Sample 2-13 was fabricated in the same manner as Sample 2-1, except that 0.02 wt. % of N-trifluoromethylbis(trifluoromethoxysulfinyl)imide represented by the above formula (17) was added as an additive to the mixed solvent.

Sample 2-14

A secondary cell as Sample 2-14 was fabricated in the same manner as Sample 2-1, except that 0.02 wt. % of N-methoxybis(trifluoromethoxysulfinyl)imide represented by the above formula (18) was added as an additive to the mixed solvent.

Sample 2-15

A secondary cell as Sample 2-15 was fabricated in the same manner as Sample 2-1, except that 0.02 wt. % of N-ethoxybis(trifluoromethoxysulfinyl)imide represented by the above formula (19) was added as an additive to the mixed solvent.

Sample 2-16

A secondary cell as Sample 2-16 was fabricated in the same manner as Sample 2-1, except that the N-methylbis(trifluoromethoxysulfinyl)imide of the above formula (12) was not added as an additive to the mixed solvent.

The secondary cells as Samples 2-1 to 2-16 fabricated as above were served to the high-temperature preservation test and the cycle test. The test results are shown in Table 7 below.

In Table 7, N-MTFMXSI stands for N-methylbis(trifluoromethoxysulfinyl)imide; N-ETFMXSI stands for N-ethylbis(trifluoromethoxysulfinyl)imide; N-PTFMXSI stands for N-propylbis(trifluoromethoxysulfinyl)imide; N-MPFEXSI stands for N-methylbis(pentafluoroethoxysulfinyl)imide; N-EPFEXSI stands for N-ethylbis(pentafluoroethoxysulfinyl)imide; N-TFMTFMXSI stands for N-trifluoromethylbis(trifluoromethoxysulfinyl)imide; N-MXTFMXSI stands for N-methoxybis(trifluoromethoxysulfinyl)imide; and N-EXTFMXSI stands for N-ethoxybis(trifluoromethoxysulfinyl)imide.

TABLE 7

| | | | Electrolyte solution | | | | | | | | | Amt of | Cap. | Cap. | |
|---|---|---|---|---|---|---|---|---|---|---|---|---|---|---|---|
| | Positive | Neg. | | | Mixed | | | Volume | | | | additive | rec. | ret. | Chrg. volt. |
| Sample | electrode | electrode | Kind | Kind | solvent | | | ratio | Kind | wt. % | Additive | wt. % | [%] | [%] | [V] |
| 2-1 | LiCoO₂ | AG | LiPF₆: | — | DMC | DEC | EC | 5:1:4 | VC | 1 | N-MTFMXSI | 0.001 | 82 | 80 | 4.20 |
| | | | 1.0 mol/l | | | | | | | | | | | | |
| 2-2 | LiCoO₂ | AG | LiPF₆: | — | DMC | DEC | EC | 5:1:4 | VC | 1 | N-MTFMXSI | 0.02 | 86 | 84 | 4.20 |
| | | | 1.0 mol/l | | | | | | | | | | | | |
| 2-3 | LiCoO₂ | AG | LiPF₆: | — | DMC | DEC | EC | 5:1:4 | VC | 1 | N-MTFMXSI | 0.5 | 87 | 85 | 4.20 |
| | | | 1.0 mol/l | | | | | | | | | | | | |
| 2-4 | LiCoO₂ | AG | LiPF₆: | — | DMC | DEC | EC | 5:1:4 | VC | 1 | N-MTFMXSI | 1 | 86 | 84 | 4.20 |
| | | | 1.0 mol/l | | | | | | | | | | | | |
| 2-5 | LiCoO₂ | AG | LiPF₆: | — | DMC | DEC | EC | 5:1:4 | VC | 1 | N-MTFMXSI | 2 | 86 | 81 | 4.20 |
| | | | 1.0 mol/l | | | | | | | | | | | | |
| 2-6 | LiCoO₂ | AG | LiPF₆: | — | DMC | DEC | EC | 5:1:4 | VC | 1 | N-MTFMXSI | 5 | 84 | 79 | 4.20 |
| | | | 1.0 mol/l | | | | | | | | | | | | |
| 2-7 | LiCoO₂ | AG | LiPF₆: | — | DMC | DEC | EC | 5:1:4 | VC | 1 | N-MTFMXSI | 0.0005 | 78 | 75 | 4.20 |
| | | | 1.0 mol/l | | | | | | | | | | | | |
| 2-8 | LiCoO₂ | AG | LiPF₆: | — | DMC | DEC | EC | 5:1:4 | VC | 1 | N-MTFMXSI | 8 | 70 | 69 | 4.20 |
| | | | 1.0 mol/l | | | | | | | | | | | | |
| 2-9 | LiCoO₂ | AG | LiPF₆: | — | DMC | DEC | EC | 5:1:4 | VC | 1 | N-ETFMXSI | 0.02 | 87 | 82 | 4.20 |
| | | | 1.0 mol/l | | | | | | | | | | | | |
| 2-10 | LiCoO₂ | AG | LiPF₆: | — | DMC | DEC | EC | 5:1:4 | VC | 1 | N-PTFMXSI | 0.02 | 85 | 80 | 4.20 |
| | | | 1.0 mol/l | | | | | | | | | | | | |
| 2-11 | LiCoO₂ | AG | LiPF₆: | — | DMC | DEC | EC | 5:1:4 | VC | 1 | N-MPFEXSI | 0.02 | 85 | 79 | 4.20 |
| | | | 1.0 mol/l | | | | | | | | | | | | |
| 2-12 | LiCoO₂ | AG | LiPF₆: | — | DMC | DEC | EC | 5:1:4 | VC | 1 | N-EPFEXSI | 0.02 | 84 | 79 | 4.20 |
| | | | 1.0 mol/l | | | | | | | | | | | | |
| 2-13 | LiCoO₂ | AG | LiPF₆: | — | DMC | DEC | EC | 5:1:4 | VC | 1 | N-TFMTFMXSI | 0.02 | 86 | 78 | 4.20 |
| | | | 1.0 mol/l | | | | | | | | | | | | |
| 2-14 | LiCoO₂ | AG | LiPF₆: | — | DMC | DEC | EC | 5:1:4 | VC | 1 | M-MXTFMXSI | 0.02 | 84 | 78 | 4.20 |
| | | | 1.0 mol/l | | | | | | | | | | | | |
| 2-15 | LiCoO₂ | AG | LiPF₆: | — | DMC | DEC | EC | 5:1:4 | VC | 1 | N-EXTFMXSI | 0.02 | 84 | 78 | 4.20 |
| | | | 1.0 mol/l | | | | | | | | | | | | |
| 2-16 | LiCoO₂ | AG | LiPF₆: | — | DMC | DEC | EC | 5:1:4 | VC | 1 | none | — | 78 | 75 | 4.20 |
| | | | 1.0 mol/l | | | | | | | | | | | | |

Evaluation

As shown in Table 7, Samples 2-1 to 2-6 and Samples 2-9 to 2-15 were better than Sample 2-16 in cycle characteristic and high-temperature preservability. In addition, Samples 2-1 to 2-6 and Samples 2-9 to 2-15 were better than Samples 1-17 and 1-18 in cycle characteristic and high-temperature preservability. Thus, it was verified that good cycle characteristic and high-temperature preservability can be obtained by addition to the electrolyte solution any of the alkanamine derivatives as represented by the above formulas (12) to (19). Besides, by comparison of Samples 2-1 to 2-8, it was confirmed that an optimum addition amount of the alkanamine derivative of the formula (12) is in the range of 0.001 to 5 wt. % based on the total amount of the electrolyte solution.

Samples 2-17 and 2-18

Sample 2-17

A mixed solvent was prepared by mixing dimethyl carbonate (DMC), 4-fluoro-1,3-dioxolan-2-one (FEC) and ethylene carbonate (EC) in a volume ratio of 6:2:2. A secondary cell as Sample 2-17 was fabricated in the same manner as Sample 2-1, except for the just-mentioned point.

Sample 2-18

A secondary cell as Sample 2-18 was fabricated in the same manner as Sample 2-17, except that the N-methylbis(trifluoromethoxysulfinyl)imide of the formula (12) was not added as an additive to the mixed solvent.

The secondary cells as Samples 2-17 and 2-18 were served to the high-temperature preservation test and the cycle test. The test results are shown in Table 8 below.

In Table 8, N-MTFMXSI stands for N-methylbis(trifluoromethoxysulfinyl)imide.

TABLE 8

| | | | Electrolyte solution | | | | | | | | | Amt of | Cap. | Cap. | Chrg. |
|---|---|---|---|---|---|---|---|---|---|---|---|---|---|---|---|
| | Positive | Neg. | | | Mixed | | | Volume | | | | additive | rec. | ret. | volt. |
| Sample | electrode | electrode | Kind | Kind | solvent | | | ratio | Kind | wt. % | Additive | wt. % | [%] | [%] | [V] |
| 2-17 | LiCoO₂ | AG | LiPF₆: | — | DMC | FEC | EC | 6:2:2 | VC | 1 | N-MTFMXSI | 0.02 | 86 | 87 | 4.20 |
| | | | 1.0 mol/l | | | | | | | | | | | | |
| 2-18 | LiCoO₂ | AG | LiPF₆: | — | DMC | FEC | EC | 6:2:2 | VC | 1 | none | — | 80 | 78 | 4.20 |
| | | | 1.0 mol/l | | | | | | | | | | | | |

As shown in Table 8, Sample 2-17 was better than Sample 2-18 in high-temperature preservability and cycle characteristic. Thus, it was found that in the case where a solvent containing 4-fluoro-1,3-dioxolan-2-one (FEC) is used, good high-temperature preservability and cycle characteristic can be obtained by addition of the alkanamine derivative as represented by the above formula (12).

Samples 2-19 and 2-20

Sample 2-19

A secondary cell as Sample 2-19 was fabricated in the same manner as Sample 2-17, except that lithium bis(trifluoromethanesulfonyl)imide (LiTFSI) was further added as an electrolyte salt to the mixed solvent in an amount of 0.1 mol/l.

Sample 2-20

A secondary cell as Sample 2-20 was fabricated in the same manner as Sample 2-19, except that the N-methylbis(trifluoromethoxysulfinyl)imide of the formula (12) was not added as an additive to the mixed solvent.

The secondary cells as Samples 2-19 and 2-20 were served to the high-temperature preservation test and the cycle test. The test results are shown in Table 9 below.

In Table 9, N-MTFMXSI stands for N-methylbis(trifluoromethoxysulfinyl)imide.

TABLE 9

| | | | Electrolyte solution | | | | | | | | | Amt of | Cap. | Cap. | Chrg. |
|---|---|---|---|---|---|---|---|---|---|---|---|---|---|---|---|
| | Positive | Neg. | | | Mixed | | | Volume | | | | additive | rec. | ret. | volt. |
| Sample | electrode | electrode | Kind | Kind | solvent | | | ratio | Kind | wt. % | Additive | wt. % | [%] | [%] | [V] |
| 2-19 | LiCoO₂ | AG | LiPF₆: | LiTFSI: | DMC | FEC | EC | 6:2:2 | VC | 1 | N-MTFMXSI | 0.02 | 87 | 87 | 4.20 |
| | | | 1.0 mol/l | 0.1 mol/l | | | | | | | | | | | |
| 2-20 | LiCoO₂ | AG | LiPF₆: | LiTFSI: | DMC | FEC | EC | 6:2:2 | VC | 1 | none | — | 83 | 78 | 4.20 |
| | | | 1.0 mol/l | 0.1 mol/l | | | | | | | | | | | |

As shown in Table 9, Sample 2-19 was better than Sample 2-20 in high-temperature preservability and cycle characteristic. Thus, it was verified that in the case where LiTFSI is used as the electrolyte salt, good high-temperature preservability and cycle characteristic can be obtained by addition of the alkanamine derivative as represented by the above formula (12).

Samples 2-21 to 2-32

Sample 2-21

A secondary cell as Sample 2-21 was fabricated in the same manner as Sample 2-1, except that LiNiO₂ powder was used as the positive electrode active material.

Sample 2-22

A secondary cell as Sample 2-22 was fabricated in the same manner as Sample 2-21, except that the N-methylbis(trifluoromethoxysulfinyl)imide of the formula (12) was not added as an additive to the mixed solvent.

Sample 2-23

A secondary cell as Sample 2-23 was fabricated in the same manner as Sample 2-1, except that LiMn₂O₄ powder was used as the positive electrode active material.

Sample 2-24

A secondary cell as Sample 2-24 was fabricated in the same manner as Sample 2-23, except that the N-methylbis(trifluoromethoxysulfinyl)imide of the formula (12) was not added as an additive to the mixed solvent.

Sample 2-25

A secondary cell as Sample 2-25 was fabricated in the same manner as Sample 2-1, except that LiCo_{0.50}Ni_{0.50}O₂ powder was used as the positive electrode active material.

### Sample 2-26>

A secondary cell as Sample 2-26 was fabricated in the same manner as Sample 2-25, except that the N-methylbis(trifluoromethoxysulfinyl)imide of the formula (12) was not added as an additive to the mixed solvent.

Sample 2-27

A secondary cell as Sample 2-27 was fabricated in the same manner as Sample 2-1, except that LiCo_{0.33}Ni_{0.33}Mn_{0.}33O₂ powder was used as the positive electrode active material.

Sample 2-28

A secondary cell as Sample 2-28 was fabricated in the same manner as Sample 2-27, except that the N-methylbis(trifluoromethoxysulfinyl)imide of the formula (12) was not added as an additive to the mixed solvent.

Sample 2-29

A secondary cell as Sample 2-29 was fabricated in the same manner as Sample 2-1, except that LiFePO₄ powder was used as the positive electrode active material.

Sample 2-30

A secondary cell as Sample 2-30 was fabricated in the same manner as Sample 2-29, except that the N-methylbis(trifluoromethoxysulfinyl)imide of the formula (12) was not added as an additive to the mixed solvent.

Sample 2-31

A secondary cell as Sample 2-31 was fabricated in the same manner as Sample 2-1, except that LiFe_{0.50}Mn_{0.50}PO₄ powder was used as the positive electrode active material.

Sample 2-32

A secondary cell as Sample 2-32 was fabricated in the same manner as Sample 2-31, except that the N-methylbis(trifluoromethoxysulfinyl)imide of the formula (12) was not added as an additive to the mixed solvent.

Samples 2-21 to 2-32 were served to the high-temperature preservation test and the cycle test. The test results are shown in Table 10 below.

In Table 10, N-MTFMXSI stands for N-methylbis(trifluoromethoxysulfinyl)imide.

TABLE 10

| | | | Electrolyte solution | | | | | | | | | Amt of | Cap. | Cap. | Chrg. |
|---|---|---|---|---|---|---|---|---|---|---|---|---|---|---|---|
| Sam- | Positive | Neg. e- | | | Mixed | | | Volume | | wt. | | additive | rec. | ret. | volt. |
| ple | electrode | lectrode | Kind | Kind | solvent | | | ratio | Kind | % | Additive | wt. % | [%] | [%] | [V] |
| 2-21 | LiNiO₂ | AG | LiPF₆: | — | DMC | DEC | EC | 5:1:4 | VC | 1 | N-MTFMXSI | 0.02 | 85 | 83 | 4.20 |
| | | | 1.0 mol/l | | | | | | | | | | | | |
| 2-22 | LiNiO₂ | AG | LiPF₆: | — | DMC | DEC | EC | 5:1:4 | VC | 1 | none | — | 79 | 76 | 4.20 |
| | | | 1.0 mol/l | | | | | | | | | | | | |
| 2-23 | LiMn₂O₄ | AG | LiPF₆: | — | DMC | DEC | EC | 5:1:4 | VC | 1 | N-MTFMXSI | 0.02 | 81 | 80 | 4.20 |
| | | | 1.0 mol/l | | | | | | | | | | | | |
| 2-24 | LiMn₂O₄ | AG | LiPF₆: | — | DMC | DEC | EC | 5:1:4 | VC | 1 | none | — | 78 | 70 | 4.20 |
| | | | 1.0 mol/l | | | | | | | | | | | | |
| 2-25 | LiCo_{0.50}Ni_{0.50}O₂ | AG | LiPF₆: | — | DMC | DEC | EC | 5:1:4 | VC | 1 | N-MTFMXSI | 0.02 | 84 | 81 | 4.20 |
| | | | 1.0 mol/l | | | | | | | | | | | | |
| 2-26 | LiCo_{0.50}Ni_{0.50}O₂ | AG | LiPF₆: | — | DMC | DEC | EC | 5:1:4 | VC | 1 | none | — | 80 | 78 | 4.20 |
| | | | 1.0 mol/l | | | | | | | | | | | | |
| 2-27 | LiCo_{0.33}Ni_{0.33}Mn_{0.33}O₂ | AG | LiPF₆: | — | DMC | DEC | EC | 5:1:4 | VC | 1 | N-MTFMXSI | 0.02 | 86 | 82 | 4.20 |
| | | | 1.0 mol/l | | | | | | | | | | | | |
| 2-28 | LiCo_{0.33}Ni_{0.33}Mn_{0.33}O₂ | AG | LiPF₆: | — | DMC | DEC | EC | 5:1:4 | VC | 1 | none | — | 83 | 78 | 4.20 |
| | | | 1.0 mol/l | | | | | | | | | | | | |
| 2-29 | LiFePO₄ | AG | LiPF₆: | — | DMC | DEC | EC | 5:1:4 | VC | 1 | N-MTFMXSI | 0.02 | 85 | 83 | 4.20 |
| | | | 1.0 mol/l | | | | | | | | | | | | |
| 2-30 | LiFePO₄ | AG | LiPF₆: | — | DMC | DEC | EC | 5:1:4 | VC | 1 | none | — | 80 | 73 | 4.20 |
| | | | 1.0 mol/l | | | | | | | | | | | | |
| 2-31 | LiFe_{0.50}Mn_{0.50}PO₄ | AG | LiPF₆: | — | DMC | DEC | EC | 5:1:4 | VC | 1 | N-MTFMXSI | 0.02 | 87 | 82 | 4.20 |
| | | | 1.0 mol/l | | | | | | | | | | | | |
| 2-32 | LiFe_{0.50}Mn_{0.50}PO₄ | AG | LiPF₆: | — | DMC | DEC | EC | 5:1:4 | VC | 1 | none | — | 83 | 75 | 4.20 |
| | | | 1.0 mol/l | | | | | | | | | | | | |

Evaluation

As shown in Table 10, Sample 2-21 was better than Sample 2-22 in high-temperature preservability and cycle characteristic. Sample 2-23 was better than Sample 2-24 in high-temperature preservability and cycle characteristic. Sample 2-25 was better than Sample 2-26 in high-temperature preservability and cycle characteristic. Sample 2-27 was better than Sample 2-28 in high-temperature preservability and cycle characteristic. Sample 2-29 was better than Sample 2-30 in high-temperature preservability and cycle characteristic. Sample 2-31 was better than Sample 2-32 in high-temperature preservability and cycle characteristic. In other words, it was found that in the case where such a positive electrode material as LiNiO₂, LiMn₂O₄, LiCo_{0.50}Ni_{0.50}O₂, LiCo_{0.33}Ni_{0.33}Mn_{0.33}O₂, and LiFe_{0.50}Mn_{0.50}PO₄ is used, good high-temperature preservability and cycle characteristic can be obtained by use of an electrolyte solution containing the alkanamine derivative as represented by the above formula (12).

Samples 2-33 to 2-42

Sample 2-33

A negative electrode was produced in the following manner.

On a negative electrode current collector 34A composed of a 15 μm-thick copper foil, silicon (Si) was deposited by an electron beam evaporation method, to form negative electrode active material layers 34B.

A secondary cell as Sample 2-33 was fabricated in the same manner as Sample 2-1, except for the just-mentioned point.

Sample 2-34

A secondary cell as Sample 2-34 was fabricated in the same manner as Sample 2-33, except that the N-methylbis(trifluoromethoxysulfinyl)imide of the formula (12) was not added as an additive to the mixed solvent.

Sample 2-35

On a negative electrode current collector 22A composed of a 15 μm-thick copper foil, tin (Sn) was deposited by a vacuum evaporation method, to form negative electrode active material layers 22B.

A secondary cell as Sample 2-35 was fabricated in the same manner as Sample 2-1, except for the just-mentioned point.

Sample 2-36

A secondary cell as Sample 2-36 was fabricated in the same manner as Sample 2-35, except that the N-methylbis(trifluoromethoxysulfinyl)imide of the formula (12) was not added as an additive to the mixed solvent.

Sample 2-37

A mixture of 50 parts by weight of Co—Si alloy powder having an average particle diameter of 10 μm as the negative electrode active material, 40 parts by weight of graphite having an average particle diameter of 15 μm, 5 parts by weight of Ketchen black and 5 parts by weight of polyvinylidene fluoride was dispersed in N-methyl-2-pyrrolidone used as a solvent, to prepare a negative electrode composition slurry.

A secondary cell as Sample 2-37 was fabricated in the same manner as Sample 2-1, except for the just-mentioned point.

Sample 2-38

A secondary cell as Sample 2-38 was fabricated in the same manner as Sample 2-37, except that the N-methylbis(trifluoromethoxysulfinyl)imide of the formula (12) was not added as an additive to the mixed solvent.

Sample 2-39

A mixture of 50 parts by weight of Co—Sn alloy powder having an average particle diameter of 10 μm as the negative electrode active material, 40 parts by weight of graphite having an average particle diameter of 15 μm, 5 parts by weight of Ketchen black and 5 parts by weight of polyvinylidene fluoride was dispersed in N-methyl-2-pyrrolidone used as a solvent, to prepare a negative electrode composition slurry.

A secondary cell as Sample 2-39 was fabricated in the same manner as Sample 2-1, except for the just-mentioned point.

Sample 2-40

A secondary cell as Sample 2-40 was fabricated in the same manner as Sample 2-39, except that the N-methylbis(trifluoromethoxysulfinyl)imide of the formula (12) was not added as an additive to the mixed solvent.

Sample 2-41

A negative electrode was produced in the following manner.

First, as raw material, Co—Sn alloy powder and carbon powder were mixed with each other in a predetermined ratio, and the powders were subjected to dry mixing in the condition where the total amount of powder was 10 g. The resulting mixture was set in a reaction vessel of a planetary ball mill produced by Ito Seisakusho Co., Ltd. together with 400 g of steel balls measuring 9 mm in diameter. After the inside of the reaction vessel was flushed with argon gas, a cycle including a rotating operation at 250 rpm for 10 minutes and a rest for 10 minutes was repeated until the total operation time reached 20 hours.

Thereafter, the reaction vessel was cooled to room temperature, and the negative electrode active material powder thus synthesized was served to composition analysis. As a result, it was found that the content of tin (Sn) was 49.5 wt. %, the content of cobalt (Co) was 29.7 wt. %, the content of carbon (C) was 19.8 wt. %, and the ratio Co/(Sn+Co) of the content of cobalt (Co) to the total content of tin (Sn) and cobalt (Co) was 37.5%. Incidentally, the content of carbon (C) was measured by a carbon-sulfur analyzer, whereas the contents of tin (Sn) and cobalt (Co) were measured by inductively coupled plasma (ICP)-atomic emission spectroscopy.

Next, a mixture of 80 parts by weight of the negative electrode active material powder, 11 parts by weight of graphite and 1 parts by weight of acetylene black as conductive agents, and 8 parts by eight of polyvinylidene fluoride as a binder was dispersed in N-methyl-2-pyrrolidone used as a solvent, to prepare a negative electrode composition slurry.

A secondary cell as Sample 2-41 was fabricated in the same manner as Sample 2-1, except for the just-mentioned points.

Sample 2-42

A secondary cell as Sample 2-42 was fabricated in the same manner as Sample 2-41, except that the N-methylbis(trifluoromethoxysulfinyl)imide of the formula (12) was not added as an additive to the mixed solvent.

Samples 2-33 to 2-42 were served to the high-temperature preservability and the cycle test. The test results are shown in Table 11 below.

In Table 11, N-MTFMXSI stands for N-methylbis(trifluoromethoxysulfinyl)imide.

TABLE 11

| | | | Electrolyte solution | | | | | | | | | Amt of | Cap. | Cap. | Chrg. |
|---|---|---|---|---|---|---|---|---|---|---|---|---|---|---|---|
| | Positive | Neg. | | | Mixed | | | Volume | | | | additive | rec. | ret. | volt. |
| Sample | electrode | electrode | Kind | Kind | solvent | | | ratio | Kind | wt. % | Additive | wt. % | [%] | [%] | [V] |
| 2-33 | LiCoO₂ | Si | LiPF₆: | — | DMC | DEC | EC | 5:1:4 | VC | 1 | N-MTFMXSI | 0.02 | 80 | 75 | 4.20 |
| | | | 1.0 mol/l | | | | | | | | | | | | |
| 2-34 | LiCoO₂ | Si | LiPF₆: | — | DMC | DEC | EC | 5:1:4 | VC | 1 | none | — | 75 | 70 | 4.20 |
| | | | 1.0 mol/l | | | | | | | | | | | | |
| 2-35 | LiCoO₂ | Sn | LiPF₆: | — | DMC | DEC | EC | 5:1:4 | VC | 1 | N-MTFMXSI | 0.02 | 81 | 71 | 4.20 |
| | | | 1.0 mol/l | | | | | | | | | | | | |
| 2-36 | LiCoO₂ | Sn | LiPF₆: | — | DMC | DEC | EC | 5:1:4 | VC | 1 | none | — | 76 | 65 | 4.20 |
| | | | 1.0 mol/l | | | | | | | | | | | | |
| 2-37 | LiCoO₂ | Co—Si | LiPF₆: | — | DMC | DEC | EC | 5:1:4 | VC | 1 | N-MTFMXSI | 0.02 | 79 | 84 | 4.20 |
| | | | 1.0 mol/l | | | | | | | | | | | | |
| 2-38 | LiCoO₂ | Co—Si | LiPF₆: | — | DMC | DEC | EC | 5:1:4 | VC | 1 | none | — | 70 | 75 | 4.20 |
| | | | 1.0 mol/l | | | | | | | | | | | | |
| 2-39 | LiCoO₂ | Co—Sn | LiPF₆: | — | DMC | DEC | EC | 5:1:4 | VC | 1 | N-MTFMXSI | 0.02 | 79 | 82 | 4.20 |
| | | | 1.0 mol/l | | | | | | | | | | | | |
| 2-40 | LiCoO₂ | Co—Sn | LiPF₆: | — | DMC | DEC | EC | 5:1:4 | VC | 1 | none | — | 80 | 75 | 4.20 |
| | | | 1.0 mol/l | | | | | | | | | | | | |
| 2-41 | LiCoO₂ | CoSnC- | LiPF₆: | — | DMC | DEC | EC | 5:1:4 | VC | 1 | N-MTFMXSI | 0.02 | 84 | 85 | 4.20 |
| | | containing | 1.0 mol/l | | | | | | | | | | | | |
| | | material | | | | | | | | | | | | | |
| 2-42 | LiCoO₂ | CoSnC- | LiPF₆: | — | DMC | DEC | EC | 5:1:4 | VC | 1 | none | — | 80 | 80 | 4.20 |
| | | containing | 1.0 mol/l | | | | | | | | | | | | |
| | | material | | | | | | | | | | | | | |

Evaluation

As shown in Table 11, Sample 2-33 was better than Sample 2-34 in high-temperature preservability and cycle characteristic. Sample 2-35 was better than Sample 2-36 in high-temperature preservability and cycle characteristic. Sample 2-37 was better than Sample 2-38 in high-temperature preservability and cycle characteristic. Sample 2-39 was better than Sample 2-40 in high-temperature preservability and cycle characteristic. Sample 2-41 was better than Sample 2-42 in high-temperature preservability and cycle characteristic. In other words, it was found that in the case where such a negative electrode material as silicon, tin, Co—Si alloy powder, Co—Sn alloy powder and a CoSnC-containing material, good high-temperature preservability and cycle characteristic can be obtained by use of an electrolyte solution containing the alkanamine derivative as represented by the above formula (12).

Samples 2-43 to 2-48

Sample 2-43

A secondary cell as Sample 2-43 was fabricated in the same manner as Sample 2-1, except that the cell was designed to have an open-circuit voltage in a fully charged state of 4.30 V, by controlling the quantity of the positive electrode active material and the quantity of the negative electrode active material.

Sample 2-44

A secondary cell as Sample 2-44 was fabricated in the same manner as Sample 2-43, except that the N-methylbis(trifluoromethoxysulfinyl)imide of the formula (12) was not added as an additive to the mixed solvent.

Sample 2-45

A secondary cell as Sample 2-45 was fabricated in the same manner as Sample 2-1, except that the cell was designed to have an open-circuit voltage in a fully charged state of 4.35 V, by controlling the quantity of the positive electrode active material and the quantity of the negative electrode active material.

Sample 2-46

A secondary cell as Sample 2-46 was fabricated in the same manner as Sample 2-45, except that the N-methylbis(trifluoromethoxysulfinyl)imide of the formula (12) was not added as an additive to the mixed solvent.

Sample 2-47

A secondary cell as Sample 2-47 was fabricated in the same manner as Sample 2-1, except that the cell was designed to have an open-circuit voltage in a fully charged state of 4.40 V, by controlling the quantity of the positive electrode active material and the quantity of the negative electrode active material.

Sample 2-48

A secondary cell as Sample 2-48 was fabricated in the same manner as Sample 2-47, except that the N-methylbis(trifluoromethoxysulfinyl)imide of the formula (12) was not added as an additive to the mixed solvent.

Samples 2-43 to 2-48 were served to the high-temperature preservation test and the cycle test. In the high-temperature preservation test and the cycle test, the charging voltage for the Samples 2-43 and 2-44 was set at 4.30 V, while the charging voltage for the Samples 2-45 and 2-46 was set at 4.35 V, and the charging voltage for the Samples 2-47 and 2-48 was set at 4.40 V. The test results are shown in Table 12 below.

In Table 12, N-MTFMXSI stands for N-methylbis(trifluoromethoxysulfinyl)imide.

TABLE 12

| | | | Electrolyte solution | | | | | | | | | Amt of | Cap. | Cap. | Chrg. |
|---|---|---|---|---|---|---|---|---|---|---|---|---|---|---|---|
| | Positive | Neg. | | | Mixed | | | Volume | | | | additive | rec. | ret. | volt. |
| Sample | electrode | electrode | Kind | Kind | solvent | | | ratio | Kind | wt. % | Additive | wt. % | [%] | [%] | [V] |
| 2-43 | LiCoO₂ | AG | LiPF₆: | — | DMC | DEC | EC | 5:1:4 | VC | 1 | N-MTFMXSI | 0.02 | 77 | 69 | 4.30 |
| | | | 1.0 mol/l | | | | | | | | | | | | |
| 2-44 | LiCoO₂ | AG | LiPF₆: | — | DMC | DEC | EC | 5:1:4 | VC | 1 | none | — | 74 | 65 | 4.30 |
| | | | 1.0 mol/l | | | | | | | | | | | | |
| 2-45 | LiCoO₂ | AG | LiPF₆: | — | DMC | DEC | EC | 5:1:4 | VC | 1 | N-MTFMXSI | 0.02 | 76 | 57 | 4.35 |
| | | | 1.0 mol/l | | | | | | | | | | | | |
| 2-46 | LiCoO₂ | AG | LiPF₆: | — | DMC | DEC | EC | 5:1:4 | VC | 1 | none | — | 69 | 40 | 4.35 |
| | | | 1.0 mol/l | | | | | | | | | | | | |
| 2-47 | LiCoO₂ | AG | LiPF₆: | — | DMC | DEC | EC | 5:1:4 | VC | 1 | N-MTFMXSI | 0.02 | 73 | 45 | 4.40 |
| | | | 1.0 mol/l | | | | | | | | | | | | |
| 2-48 | LiCoO₂ | AG | LiPF₆: | — | DMC | DEC | EC | 5:1:4 | VC | 1 | none | — | 65 | 10 | 4.40 |
| | | | 1.0 mol/l | | | | | | | | | | | | |

Evaluation

As shown in Table 12, Sample 2-43 was better than Sample 2-44 in high-temperature preservability and cycle characteristic. Sample 2-45 was better than Sample 2-46 in high-temperature preservability and cycle characteristic. Sample 2-47 was better than Sample 2-48 in high-temperature preservability and cycle characteristic. In short, it was found that in the case where the charging voltage is set at a value of not less than 4.30 V, good high-temperature preservability and cycle characteristic can be obtained by use of an electrolyte solution containing the alkanamine derivative as represented by the above formula (12).

### 7. Other Embodiments

The present application is not limited to the above-described embodiments thereof, and various modifications and applications are possible within the scope of the application. For instance, the use for the electrolyte solution pertaining to the application is not necessarily limited to cells; the electrolyte solution may, for example, be used for other electrochemical devices such as capacitors.

While the cases where an electrolyte solution or a gelled electrolyte having an electrolyte solution held by a polymer is used as the electrolyte for a cell according to an embodiment have been described in the above embodiments and Examples, other types of electrolyte may also be used. Examples of the other types of electrolyte include: mixtures of the electrolyte solution with an ionically conductive ceramic, an ionically conductive glass or an ionically conductive inorganic compound such as an ionic crystal, etc.; mixtures of the electrolyte solution with other inorganic compounds; and mixtures of the gelled electrolyte with the inorganic compounds.

Besides, while the cases where lithium is used for electrode reactions have been described in the above embodiments and Examples, this is not limitative of the present application. The application is also applicable to the cases where other alkali metal such as sodium (Na), potassium (K), etc. is used, or an alkaline earth metal such as magnesium (Mg), calcium (Ca), etc. is used, or other light metal such as aluminum (Al) is used; in such cases, also, effects identical or similar to those in the above-described embodiments and Examples can be obtained.

Further, while the cells having a cylindrical type or laminate film type cell structure and the cells having a wound (roll type) electrode structure have been described in the above embodiments and Examples, these cell structures are not limitative of the present application. The application is also applicable to cells of other cell structures such as angular type, coin type, button type, etc. and cells having a stack structure in which electrodes are stacked; in such cases, also, effects identical or similar to those in the above-described embodiments and Examples can be obtained.

It should be understood that various changes and modifications to the presently preferred embodiments described herein will be apparent to those skilled in the art. Such changes and modifications can be made without departing from the spirit and scope and without diminishing its intended advantages. It is therefore intended that such changes and modifications be covered by the appended claims.

The application is claimed as follows:

1. An electrolyte, comprising:
a solvent;
an electrolyte salt; and
an alkanamine derivative represented by the following formula (1): 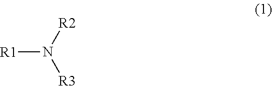
where R1 is an alkyl group of 1 to 3 carbon atoms which may have a substituent group, and R2 and R3 are each independently a sulfonyl group having a substituent group of 1 to 3 carbon atoms or a sulfinyl group having a substituent group of 1 to 3 carbon atoms.

2. The electrolyte according to claim 1,
wherein the alkanamine derivative represented by the above formula (1) is an alkanamine derivative represented by the following formula (2) or (3): 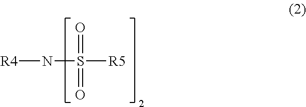
where R4 is an alkyl group of 1 to 3 carbon atoms, an alkoxyl group of 1 to 3 carbon atoms, or a perfluoroalkyl group of 1 to 3 carbon atoms, and R5 is a perfluoroalkyl group of 1 to 3 carbon atoms, 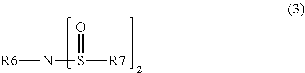
where R6 is an alkyl group of 1 to 3 carbon atoms, an alkoxyl group of 1 to 3 carbon atoms, or a perfluoroalkyl group of 1 to 3 carbon atoms, and R7 is a perfluoroalkoxyl group of 1 to 3 carbon atoms.

3. The electrolyte according to claim 1,
wherein the content of the alkanamine derivative represented by the above formula (1) is in the range of 0.001 to 5 mass %.

4. A cell, comprising:
a positive electrode;
a negative electrode; and
an electrolyte including a solvent and an electrolyte salt,
wherein the electrolyte includes an alkanamine derivative represented by the following formula (1): 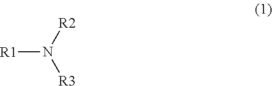
where R1 is an alkyl group of 1 to 3 carbon atoms which may have a substituent group, and R2 and R3 are each independently a sulfonyl group having a substituent group of 1 to 3 carbon atoms or a sulfinyl group having a substituent group of 1 to 3 carbon atoms.

5. The cell according to claim 4,
wherein the negative electrode includes as a component element a carbon material, lithium metal, or at least one selected from among metallic and semimetallic elements which are capable of occluding and releasing lithium.

6. The cell according to claim 4,
wherein the negative electrode includes at least one selected from the group consisting of elementary substance, alloys and compounds of silicon, and elementary substance, alloys and compounds of tin.

7. The cell according to claim 4,
wherein an open-circuit voltage in a fully charged state is in the range of 4.30 to 5.00 V.

8. The cell according to claim 4,
wherein the electrolyte is a gelled electrolyte in which an electrolyte solution containing the solvent and the electrolyte salt is supported by a polymer.
